(19) United States
(12) Patent Application Publication
(10) Pub. No.: US 2026/0066951 A1
(43) Pub. Date: Mar. 5, 2026

(54) LARGE-BANDWIDTH RECONFIGURABLE INTELLIGENT SURFACE COMMUNICATION

(71) Applicant: QUALCOMM INCORPORATED, San Diego, CA (US)

(72) Inventors: Min Huang, Beijing (CN); Wei Xi, Beijing (CN); Hao Xu, Beijing (CN)

(21) Appl. No.: 19/100,476

(22) PCT Filed: Sep. 16, 2022
(86) PCT No.: PCT/CN2022/119244

§ 371 Date: Jan. 31, 2025

(51) Int. Cl. H04B 7/04

(52) U.S. Cl. CPC H04B 7/04013

(57) ABSTRACT

Methods, systems, and devices for large-bandwidth reconfigurable intelligent surface communication (RIS) are described. A network entity (NE) may transmit a first control message to the RIS indicating a frequency and a bandwidth for a carrier of a communication signal to be used to communicate with one or more users. The RIS may transmit to the NE a second control message identifying a quantity for multiple frequency domain segments for the bandwidth of the communication signal. The NE may then communicate a communication signal with the one or more users via the RIS, for each frequency domain segment of the multiple frequency domain segments, on the frequency domain segment during a time occasion of multiple time occasions, each time occasion of the multiple time occasions corresponding to a respective frequency domain segment of the multiple frequency domain segments.

### CROSS REFERENCE

This application is a 371 National Stage of PCT Application No. PCT/CN2022/119244, filed on Sep. 16, 2022, entitled “LARGE-BANDWIDTH RECONFIGURABLE INTELLIGENT SURFACE COMMUNICATION”, and assigned to the assignee hereof. The disclosure of the prior application is considered part of and is incorporated by reference into this patent application.

### FIELD OF TECHNOLOGY

The following relates to wireless communications, including large-bandwidth reconfigurable intelligent surface communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support large-bandwidth reconfigurable intelligent surface (RIS) communication. For example, the described techniques provide for RIS beamforming where a single bandwidth is divided into frequency domain segments, each frequency domain segment associated with a single configuration of the reflective elements. Different configurations of the reflective elements may be mapped to each frequency domain segment, and the configurations of the reflective elements time division multiplexed. A network entity (NE) may transmit a first control message to the RIS indicating a frequency and a bandwidth for a carrier of a communication signal to be used to communicate with one or more users (e.g., one or more UEs or other NEs). The RIS may transmit to the NE a second control message identifying a quantity for a set of frequency domain segments including multiple segments for the bandwidth of the communication signal. The NE may then communicate a communication signal (uplink or downlink) with the one or more users via the RIS for each frequency domain segment of the set of frequency domain segments on the frequency domain segment during a time occasion of a plurality of time occasions, each time occasion of the set of time occasions corresponding to a respective frequency domain segment of the set of frequency domain segments.

A method for wireless communication at a network entity is described. The method may include transmitting, to a RIS, a first control message indicating a frequency and a bandwidth for a carrier of a communication signal, receiving, from the RIS at least in part in response to the first control message, a second control message identifying a quantity for a set of multiple frequency domain segments for the bandwidth of the communication signal, and communicating, via the RIS for each frequency domain segment of the set of multiple frequency domain segments, the communication signal on the frequency domain segment during a time occasion of a set of multiple time occasions, each time occasion of the set of multiple time occasions corresponding to a respective frequency domain segment of the set of multiple frequency domain segments.

An apparatus for wireless communication at a network entity is described. The apparatus may include a processor, memory coupled with the processor, and instructions stored in the memory. The instructions may be executable by the processor to cause the apparatus to transmit, to a RIS, a first control message indicating a frequency and a bandwidth for a carrier of a communication signal, receive, from the RIS at least in part in response to the first control message, a second control message identifying a quantity for a set of multiple frequency domain segments for the bandwidth of the communication signal, and communicate, via the RIS for each frequency domain segment of the set of multiple frequency domain segments, the communication signal on the frequency domain segment during a time occasion of a set of multiple time occasions, each time occasion of the set of multiple time occasions corresponding to a respective frequency domain segment of the set of multiple frequency domain segments.

Another apparatus for wireless communication at a network entity is described. The apparatus may include means for transmitting, to a RIS, a first control message indicating a frequency and a bandwidth for a carrier of a communication signal, means for receiving, from the RIS at least in part in response to the first control message, a second control message identifying a quantity for a set of multiple frequency domain segments for the bandwidth of the communication signal, and means for communicating, via the RIS for each frequency domain segment of the set of multiple frequency domain segments, the communication signal on the frequency domain segment during a time occasion of a set of multiple time occasions, each time occasion of the set of multiple time occasions corresponding to a respective frequency domain segment of the set of multiple frequency domain segments.

A non-transitory computer-readable medium storing code for wireless communication at a network entity is described. The code may include instructions executable by a processor to transmit, to a RIS, a first control message indicating a frequency and a bandwidth for a carrier of a communication signal, receive, from the RIS at least in part in response to the first control message, a second control message identifying a quantity for a set of multiple frequency domain segments for the bandwidth of the communication signal, and communicate, via the RIS for each frequency domain segment of the set of multiple frequency domain segments, the communication signal on the frequency domain segment during a time occasion of a set of multiple time occasions, each time occasion of the set of multiple time occasions corresponding to a respective frequency domain segment of the set of multiple frequency domain segments.

In some examples of the method, apparatuses, and non-transitory computer-readable medium described herein, transmitting the first control message may include operations, features, means, or instructions for transmitting, to the RIS, an indication of an incident angle of the communication signal at the RIS, an indication of a reflection angle for the communication signal at the RIS, or both.

In some examples of the method, apparatuses, and non-transitory computer-readable medium described herein, transmitting the first control message may include operations, features, means, or instructions for transmitting, to the RIS, an indication of position information for the communication signal that may be incident at the RIS, an indication of position information for the communication signal that may be reflected from the RIS, or both.

In some examples of the method, apparatuses, and non-transitory computer-readable medium described herein, receiving the second control message may include operations, features, means, or instructions for receiving an indication of the quantity of the set of multiple the frequency domain segments, where each of the set of multiple frequency domain segments may be evenly allocated in the bandwidth.

In some examples of the method, apparatuses, and non-transitory computer-readable medium described herein, receiving the second control message may include operations, features, means, or instructions for receiving an indication of the quantity of the set of multiple the frequency domain segments and a respective bandwidth for each frequency domain segment of the frequency domain segments.

In some examples of the method, apparatuses, and non-transitory computer-readable medium described herein, at least one of the set of multiple frequency domain segments may be unevenly allocated in the bandwidth.

Some examples of the method, apparatuses, and non-transitory computer-readable medium described herein may further include operations, features, means, or instructions for transmitting, to the RIS for each time occasion of the set of multiple time occasions, an indication of a frequency domain segment of the set of multiple frequency domain segments to be used during the time occasion.

Some examples of the method, apparatuses, and non-transitory computer-readable medium described herein may further include operations, features, means, or instructions for transmitting, to the RIS, an indication of a correspondence between each time occasion of the set of multiple time occasions and the respective frequency domain segment of the set of multiple frequency domain segments.

In some examples of the method, apparatuses, and non-transitory computer-readable medium described herein, the second control message includes a set of multiple indicators corresponding to the set of multiple frequency domain segments and the method, apparatuses, and non-transitory computer-readable medium may include further operations, features, means, or instructions for determining a correspondence between each time occasion of the set of multiple time occasions and the respective frequency domain segment of the set of multiple frequency domain segments based on an order of the set of multiple indicators within the second control message.

Some examples of the method, apparatuses, and non-transitory computer-readable medium described herein may further include operations, features, means, or instructions for communicating, via the RIS, with a first user equipment (UE) during a first time occasion of the set of multiple time occasions using a first frequency domain segment of the set of multiple frequency domain segments and communicating with a second UE during the first time occasion using a second frequency domain segment of the set of multiple frequency domain segments at least in part in response to the first control message.

A method for wireless communication at a RIS is described. The method may include receiving a first control message indicating a frequency and a bandwidth for a carrier, transmitting, at least in part in response to the first control message, a second control message identifying a quantity for a set of multiple frequency domain segments for the bandwidth, the set of multiple frequency domain segments identified based on the frequency, the bandwidth, and one or more of an angle or a position associated with the carrier, and controlling a set of reflective elements of the RIS to reflect a communication signal during a set of multiple time occasions according to the set of multiple frequency domain segments, each time occasion of the set of multiple time occasions corresponding to a respective frequency domain segment of the set of multiple frequency domain segments.

An apparatus for wireless communication at a RIS is described. The apparatus may include a processor, memory coupled with the processor, and instructions stored in the memory. The instructions may be executable by the processor to cause the apparatus to receive a first control message indicating a frequency and a bandwidth for a carrier, transmit, at least in part in response to the first control message, a second control message identifying a quantity for a set of multiple frequency domain segments for the bandwidth, the set of multiple frequency domain segments identified based on the frequency, the bandwidth, and one or more of an angle or a position associated with the carrier, and control a set of reflective elements of the RIS to reflect a communication signal during a set of multiple time occasions according to the set of multiple frequency domain segments, each time occasion of the set of multiple time occasions corresponding to a respective frequency domain segment of the set of multiple frequency domain segments.

Another apparatus for wireless communication at a RIS is described. The apparatus may include means for receiving a first control message indicating a frequency and a bandwidth for a carrier, means for transmitting, at least in part in response to the first control message, a second control message identifying a quantity for a set of multiple frequency domain segments for the bandwidth, the set of multiple frequency domain segments identified based on the frequency, the bandwidth, and one or more of an angle or a position associated with the carrier, and means for controlling a set of reflective elements of the RIS to reflect a communication signal during a set of multiple time occasions according to the set of multiple frequency domain segments, each time occasion of the set of multiple time occasions corresponding to a respective frequency domain segment of the set of multiple frequency domain segments.

A non-transitory computer-readable medium storing code for wireless communication at a RIS is described. The code may include instructions executable by a processor to receive a first control message indicating a frequency and a bandwidth for a carrier, transmit, at least in part in response to the first control message, a second control message identifying a quantity for a set of multiple frequency domain segments for the bandwidth, the set of multiple frequency domain segments identified based on the frequency, the bandwidth, and one or more of an angle or a position associated with the carrier, and control a set of reflective elements of the RIS to reflect a communication signal during a set of multiple time occasions according to the set of multiple frequency domain segments, each time occasion of the set of multiple time occasions corresponding to a respective frequency domain segment of the set of multiple frequency domain segments.

Some examples of the method, apparatuses, and non-transitory computer-readable medium described herein may further include operations, features, means, or instructions for determining, for each candidate frequency domain segment of a set of multiple candidate frequency domain segments and for each candidate configuration of a set of candidate configurations of the set of reflective elements, a signal power at a center frequency of the candidate frequency domain segment using the candidate configuration based on the frequency, the bandwidth, and the one or more of the angle or the position and selecting the set of multiple frequency domain segments from the set of multiple candidate frequency domain segments based on a set of signal powers for the plurality frequency domain segments satisfying a reflected signal power threshold, where the second control message identifies the quantity of the selected set of multiple frequency domain segments.

Some examples of the method, apparatuses, and non-transitory computer-readable medium described herein may further include operations, features, means, or instructions for determining, for each candidate frequency domain segment of a set of multiple candidate frequency domain segments and for each candidate configuration of a set of candidate configurations of the set of reflective elements, a signal power summed across a set of frequencies of the candidate frequency domain segment using the candidate configuration based on the frequency, the bandwidth, and the one or more of the angle or the position and selecting the set of multiple frequency domain segments from the set of multiple candidate frequency domain segments based on a set of signal powers for the plurality frequency domain segments satisfying a reflected signal power threshold, where the second control message identifies the quantity of the selected set of multiple frequency domain segments.

In some examples of the method, apparatuses, and non-transitory computer-readable medium described herein, receiving the first control message may include operations, features, means, or instructions for receiving an indication of the one or more of the angle or the position, the one or more of the angle or the position including an indication of an incident angle of the communication signal at the RIS, an indication of a reflection angle for the communication signal at the RIS, or both.

In some examples of the method, apparatuses, and non-transitory computer-readable medium described herein, receiving the first control message may include operations, features, means, or instructions for receiving an indication of the one or more of the angle or the position, the one or more of the angle or the position including an indication of position information for the communication signal that may be incident at the RIS, an indication of position information for the communication signal that may be reflected from the RIS, or both.

In some examples of the method, apparatuses, and non-transitory computer-readable medium described herein, transmitting the second control message may include operations, features, means, or instructions for transmitting an indication of the quantity of the set of multiple the frequency domain segments, where each of the set of multiple frequency domain segments may be evenly allocated in the bandwidth.

In some examples of the method, apparatuses, and non-transitory computer-readable medium described herein, transmitting the second control message may include operations, features, means, or instructions for transmitting an indication of the quantity of the set of multiple the frequency domain segments and a respective bandwidth for each frequency domain segment of the frequency domain segments.

In some examples of the method, apparatuses, and non-transitory computer-readable medium described herein, at least one of the set of multiple frequency domain segments may be unevenly allocated in the bandwidth.

Some examples of the method, apparatuses, and non-transitory computer-readable medium described herein may further include operations, features, means, or instructions for receiving, for each time occasion of the set of multiple time occasions, an indication of a frequency domain segment of the set of multiple frequency domain segments to be used during the time occasion.

Some examples of the method, apparatuses, and non-transitory computer-readable medium described herein may further include operations, features, means, or instructions for receiving an indication of a correspondence between each time occasion of the set of multiple time occasions and the respective frequency domain segment of the set of multiple frequency domain segments.

In some examples of the method, apparatuses, and non-transitory computer-readable medium described herein, the second control message includes a set of multiple indicators corresponding to the set of multiple frequency domain segments and the method, apparatuses, and non-transitory computer-readable medium may include further operations, features, means, or instructions for ordering the set of multiple indicators within the second control message in accordance with a correspondence between each time occasion of the set of multiple time occasions and the respective frequency domain segment of the set of multiple frequency domain segments.

### BRIEF DESCRIPTION OF THE DRAWINGS

FIG. 1 illustrates an example of a wireless communications system that supports large-bandwidth reconfigurable intelligent surface (RIS) communication in accordance with one or more aspects of the present disclosure.

FIG. 2 illustrates an example of a network architecture that supports large-bandwidth RIS communication in accordance with one or more aspects of the present disclosure.

FIG. 3 illustrates an example of a wireless communications system that supports large-bandwidth RIS communication in accordance with one or more aspects of the present disclosure.

FIG. 4 illustrates an example of a process flow that supports large-bandwidth RIS communication in accordance with one or more aspects of the present disclosure.

FIG. 5 illustrates an example of a frequency domain segmentation that supports large-bandwidth RIS communication in accordance with one or more aspects of the present disclosure.

FIG. 6 illustrates an example of a resource allocation that supports large-bandwidth RIS communication in accordance with one or more aspects of the present disclosure.

FIGS. 7 and 8 show block diagrams of devices that support large-bandwidth RIS communication in accordance with one or more aspects of the present disclosure.

FIG. 9 shows a block diagram of a communications manager that supports large-bandwidth RIS communication in accordance with one or more aspects of the present disclosure.

FIG. 10 shows a diagram of a system including a device that supports large-bandwidth RIS communication in accordance with one or more aspects of the present disclosure.

FIGS. 11 through 16 show flowcharts illustrating methods that support large-bandwidth RIS communication in accordance with one or more aspects of the present disclosure.

### DETAILED DESCRIPTION

Some wireless communications systems may implement a reconfigurable intelligent surfaces (RIS) to reflect signaling towards a target device (e.g., a UE or a network entity (NE)), for example to extend coverage for wireless communication devices. A RIS may use one or more reflective elements to reflect, or propagate, an incident carrier in a desired direction in a process that may be referred to as RIS reflection beamforming. For a RIS, the amplitude and phase coefficient for each reflective element of the RIS may vary with frequency. The relationship between frequency of the carrier and the amplitude and phase may be non-linear and hardware-specific, depending on the specific structure of the RIS. Ultra-high data rate applications, for example as contemplated for 6G, are likely to require larger bandwidths than bandwidths supported by 3G, 4G, and 5G, for example, greater than 500 MHz or greater than 1 GHZ. A RIS may be used to increase beamforming gain and throughput relative to no RIS for such applications. However, a RIS may be capable of applying a single configuration for each of its reflective elements at a single time, but not two or more configurations per reflective element. Because the amplitude and phase coefficients for the reflective elements vary with frequency—and vary more across large frequency ranges such as 500 MHz or 1 GHZ—the large bandwidth may have significant variability in the amplitude and phase coefficients (e.g., relatively larger variability than smaller frequency ranges). A single configuration for each of the reflective elements across this large bandwidth may thus result in large variability in gain across the bandwidth, and relatively poor communication throughput.

Techniques for RIS beamforming may be used where a single bandwidth is divided into frequency domain segments, each frequency domain segment associated with a single configuration of the reflective elements. Different configurations of the reflective elements may be mapped to each frequency domain segment, and the configurations of the reflective elements time division multiplexed, so that the RIS uses a single configuration at a time. The NE may then use the RIS with a bandwidth (e.g., a relatively large bandwidth) for a single user or group of users, and the remaining time and frequency resources used by the NE for other communication purposes, for example non-RIS communications or communications via a different RIS.

To support the frequency segmentation, in part because the configuration of the RIS may be RIS hardware specific, the NE may provide to the RIS the frequency and bandwidth of the carrier that is to be reflection beamformed by the RIS. The RIS may then determine a quantity (number) of frequency domain segments that it supports to optimize the amplitude and frequency coefficients of RIS reflective elements for the incident and reflected angles to and from the RIS. In one example, the NE may provide the incident and reflective angle information to the RIS. In a second example, the NE may provide incident position and reflective position information (e.g., physical position of NE and UE relative to RIS) information to the RIS, which the RIS may use to determine the incident and reflective angles. In a third example, the RIS may determine the incident and reflective angles via a beamsweeping procedure. After determining the frequency domain segments for the carrier, the RIS may then provide the frequency domain segment quantity to the NE. The NE may then schedule resources and communicate (e.g., uplink or downlink) via the RIS using the carrier according to the frequency domain segments.

Aspects of the disclosure are initially described in the context of wireless communications systems. Aspects of the disclosure are further illustrated by and described with reference to a frequency domain segmentation, a time-frequency resource allocation, a process flow that relate to RIS communication. Aspects of the disclosure are further illustrated by and described with reference to apparatus diagrams, system diagrams, and flowcharts that relate to large-bandwidth RIS communication.

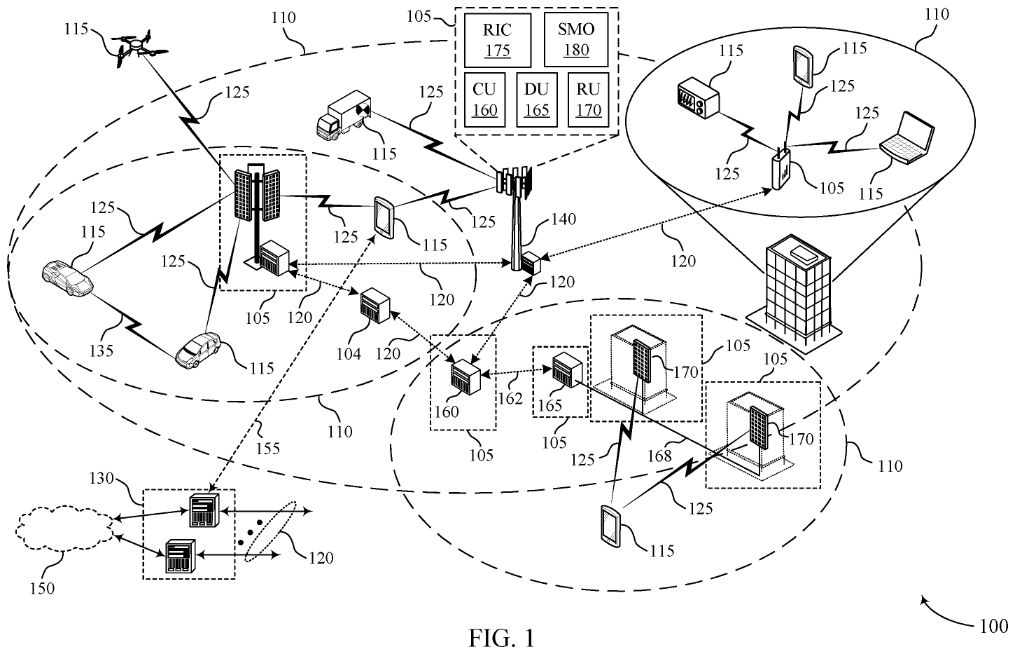

FIG. 1 illustrates an example of a wireless communications system 100 that supports large-bandwidth RIS communication in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some examples of the UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support RIS communication (e.g., large-bandwidth RIS communication) as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, 80, 160, 500, 1,000, or 1,600 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Nr may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna array's (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A network entity 105 may transmit a first control message to a RIS indicating a frequency and a bandwidth for a carrier of a communication signal to be used to communicate with one or more users, such as a UE 115 or another network entity 105. The RIS may transmit to the network entity 105 a second control message identifying a quantity for multiple frequency domain segments for the bandwidth of the communication signal. The network entity 105 may then communicate a communication signal with the one or more users via the RIS on the frequency domain segment during a time occasion of multiple time occasions. In some examples, the communication signal may be a signal transmitted from the network entity 105 that is incident on the RIS and reflected to a user (e.g., a downlink signal to a UE 115). Additionally, or alternatively, the communication signal may be a signal transmitted from the one or more users that is incident on the RIS and reflected to the network entity 105 (e.g., an uplink signal from a UE 115). Each frequency domain segment of the multiple frequency domain segments may be communicated on during different time occasions, for example according to a time division multiplexing allocation. Each time occasion of the multiple time occasions may correspond to a respective frequency domain segment of the multiple frequency domain segments. Time-frequency resources not used for communication via the RIS may be used by the network entity 105 to communicate with other users directly, or via another RIS.

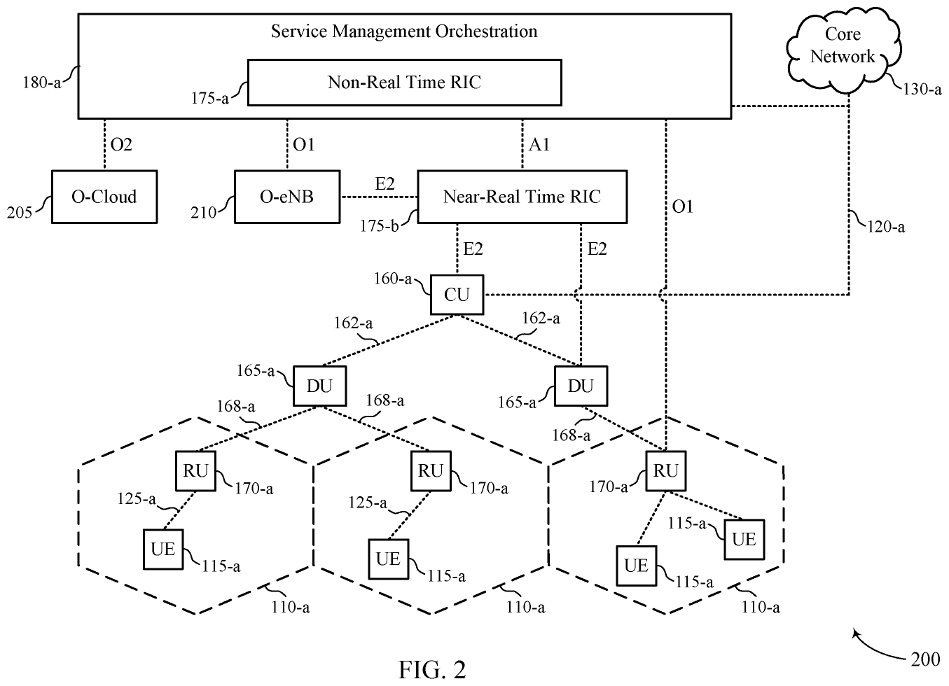

FIG. 2 illustrates an example of a network architecture 200 (e.g., a disaggregated base station architecture, a disaggregated RAN architecture) that supports large-bandwidth RIS communication in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., AI policies).

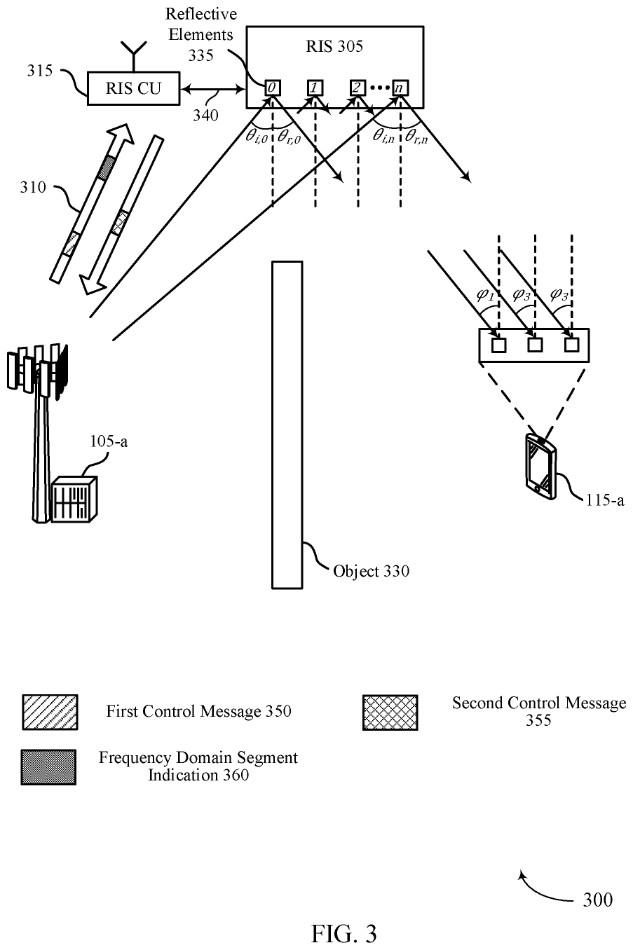

FIG. 3 illustrates an example of a wireless communications system 300 that supports large-bandwidth RIS communication in accordance with one or more aspects of the present disclosure. The wireless communications system 300 may implement or be implemented to realize aspects of the wireless communications system 100 or network architecture 200. For example, the wireless communications system 300 illustrates communication between a UE 115-a and a network entity 105-a via a RIS 305, which may be examples of corresponding devices described herein, including with reference to FIG. 1, FIG. 2, or both. In some cases, the UE 115-a and the network entity 105-a may establish communications via the RIS 305, at least in part based on control messages exchanged on a communication link 310 between network entity 105-a and a RIS CU 315 that controls RIS 305.

As used herein, the term “RIS” (reconfigurable intelligent surface) may be used to refer to a device that includes one or more reflective elements 335, such as RIS 305, that is controlled by a RIS CU 315. The term “RIS” may also refer to the combination of the RIS CU 315 and the RIS 305 that includes the one or more reflective elements 335. RIS CU 315 and RIS 305 may be co-located, or physically separated but coupled via a communication interface 340, which be wired, wireless, or a combination of wired and wireless. In some aspects, a RIS CU 315 may be coupled with a RIS 305 via hardware (such as via a fiber optic cable). In some other aspects, a RIS CU 315 may be non-co-located with a RIS 305 and may configure the RIS 305 via over-the-air signaling. The RIS may also be or be incorporated into another network device in some examples.

In some examples, the wireless communications system 300 may employ massive MIMO (e.g., 5G massive MIMO) to increase an achievable throughput between two communicating devices. For example, the wireless communications system 300 may achieve relatively high beamforming gain by using one or more active antenna units (AAU), individual radio frequency chains per antenna port, or the like. However, using AAUs to increase throughput may cause relatively high power consumption. Thus, the wireless communications system may implement one or more RISs 305 to extend coverage with negligible increase to power consumption.

In some cases, network entity 105-a may establish a communication link 310 for transmitting or receiving control signaling, data, or both to and from UE 115-a via the RIS 305, which may be a near passive device (e.g., may not have power amplifiers). In some cases, the network entity 105-a may be an example of a base station, as described with reference to FIG. 1 or FIG. 2. The network entity 105-a may be in communication with one or more other network entities, such as a controller of the RIS (e.g., a RIS CU 315). The RIS CU 315 may be referred to as a network entity, or any other controlling device, and may communicate with the network entity 105-a via the communication link 310.

In some cases, a network entity 105-a and a UE 115-a may attempt to establish a communication link 310 with each other using a beamforming technique and via an assisting device controlled by an assisting node. In some aspects, such an assisting device may include or be an example of a RIS 305, and such an assisting node may include or be an example of a RIS CU 315 or some other device capable of CU functionality (e.g., any device capable of wirelessly transmitting or receiving or capable of configuring or otherwise controlling one or more assisting devices). The RIS 305 may be a near-passive device capable of reflecting an impinging or incident wave to a desired location or in a desired direction.

As illustrated by the wireless communications system 300, a network entity 105-a may communicate with a UE 115-a by using a RIS 305 to reflect one or more beams to a UE 115-a around an object 330. In some cases, the object 330 may block or otherwise inhibit a line-of-sight (LoS) link between the network entity 105-a and the UE 115-a. The beam from the RIS 305 may have a main lobe and one or more sidelobes. A RIS CU 315 may configure a reflection characteristic of the RIS 305 to control the reflection direction from the RIS 305. For example, the RIS CU 315 may control one or more reflective elements 335 of the RIS 305. In some cases, the network entity 105-a may configure or control the RIS CU 315, such that the network entity 105-a may effectively configure or control the reflection direction of the RIS 305. For example, a network entity 105-a may transmit messaging to the RIS CU 315 indicating a configuration of the RIS 305 and the RIS CU 315 may configure the RIS 305 accordingly. In some aspects, a configuration of the RIS 305 may be for a receive beam, such as a directional beam or configuration for directional “reception” of signaling, and a reflected beam, such a directional beam or configuration for directional reflection of the signaling. Further, although described herein as a “receive” beam, a receive beam associated with a configuration of the RIS 305 may refer to reception as part of a reflecting (as opposed to, for example, as part of a decoding). In some examples, wireless communications system 300 may illustrate an example of transmissions from a network entity 105-a to a UE 115-a (which may be referred to as downlink). In some other examples, the transmissions may be from the UE 115-a to the network entity 105-a (which may be referred to as uplink), to a UE 115 from UE 115-a or from a UE 115 to UE 115-a (either or both of which may be referred to as sidelink), to a network entity 105 from network entity 105-a or from a network entity 105 to network entity 105-a (for example Xn communications), or any combination thereof.

A RIS 305 may function similarly to a mirror or other reflective surface in its ability to reflect incident beams or waves (such as light waves), but may differ in that a RIS 305 may include one or more components that may control how an incident beam or wave is reflected (such that an angle of incidence can be different than an angle of reflection). Additionally, or alternatively, the RIS 305 may control a shape of a reflected beam or wave, such as via energy focusing or energy nulling via constructive interference or destructive interference, respectively. For example, a RIS 305 may include a quantity of reflective elements 335 that each have a controllable delay, phase, or polarization, or any combination thereof. The RIS CU 315 may configure each of the reflective elements 335 to control how an incident beam or wave may be reflected or to control a shape of a reflected beam or wave. A RIS 305 may be an example of or may otherwise be referred to as a software-controlled metasurface, a configurable reflective surface, a reflective intelligent surface, or a configurable intelligent surface, and may sometimes be a metal surface (e.g., a copper surface) including a quantity of reflective elements 335.

In some examples, a transmitting wireless device, such as the network entity 105-a, may be relatively far from a receiving wireless device, such as the UE 115-a, which may be referred to as far field. Similarly, the transmitting wireless device may be relatively close to the receiving wireless device, which may be referred to as near field. In some cases, the network entity 105-a may determine a distance between the network entity 105-a and the UE 115-a to determine whether the UE 115-a is far field or near field. The network entity 105-a may compare the distance to a threshold, such that if the distance is greater than the threshold, the UE 115-a may be far field, and if the distance is less than the threshold, the UE 115-a my be near field. In some examples, the network entity 105-a may calculate the threshold according to a formula (e.g.,

$$0.62 √ \frac{{D}^{3}}{λ} or \frac{2 {D}^{2}}{λ} ,$$

where D is an antenna array panel width and λ is a wavelength).

In some cases, when the distance between the transmitting wireless device and the target object, such as the UE 115-a or the network entity 105-a, is greater than the threshold (e.g., relatively long or far), the radio wave may be or assumed to be and treated as planar. For a planar wave, the wave front may be perpendicular to the radio wave propagation direction. In some other cases, when the distance between the transmitting wireless device and the target object is less than the threshold (e.g., relatively short or near), the radio wave may be or assumed to be and treated as non-planar. For a non-planar wave, the wave front may be spherical.

For example, if the target object is far field, one or more angles, θₙ, between an antenna panel of a network entity 105-a and an antenna panel of the UE 115-a may be the same, where n is the number of antenna panel pairs actively transmitting and receiving (e.g., for far-field: θ₁=θ₂=θ₃). That is, each antenna element of the transmitter may send signals to a single antenna element of the receiver at an angle, θₙ, where θₙ is the same for each antenna element. In some other examples, if the target object is near field, one or more angles may be different for each antenna element of the transmitter, such that a target object may receive signals from each antenna element of the transmitter at different antenna elements of the receiver and according to different angles. That is, a first antenna element of the transmitter, Element 1, may send signals to multiple antenna elements of the receiver according to different angles (e.g., for 3 antenna elements at the receiver, Element 1 may send signals at angles θ₁, θ₂, θ₃, where θ₁≠θ₂≠θ₃). Similarly, a second antenna element of the transmitter, Element 2, may send signals to multiple antenna elements of the receiver according to different angles (e.g., for 3 antenna elements at the receiver, Element 2 may send signals at angles φ₁, φ₂, φ₃, where φ₁≠φ₂≠φ₃). In some cases, the angles for Element 1 may be different than the angles for Element 2 (e.g., θᵢ≠φᵢ, where i may be a number of antenna elements at the receiver, and i=1˜3).

In some examples, if the transmitter or receiver lie in the far-field of a surface of the RIS 305, when a signal is transmitted toward the RIS 305 at incident angle θᵢ, the equivalent channel response value of the nth reflective element 335 of the RIS 305 at a reflection angle θᵣ may be calculated according to Equation 1:

$${h}_{n} = {e}^{j \frac{2 π {d}_{n}}{λ} ( sin {θ}_{i} + sin {θ}_{r} )} \cdot {α}_{n} {e}^{j {φ}_{n}} \qquad ( 1 )$$

where αₙe^{jφ}^{ₙ} is the reflection coefficient of the reflective element 335, dₙ is the distance between the nth reflective element 335 to the reference reflective element 335 (Element 0), λ is wavelength. Similarly, the overall equivalent channel response value of the all the reflective elements 335, N, of the RIS 305 at reflection angle θᵣ may be calculated according to Equation 2:

$$h = {\sum }_{n = 0}^{N - 1} {h}_{n} = {\sum }_{n = 0}^{N - 1} {e}^{j \frac{2 π {d}_{n}}{λ} ( sin {θ}_{i} + sin {θ}_{r} )} \cdot {α}_{n} {e}^{j {φ}_{n}} \qquad ( 2 )$$

Thus, if the reflection coefficient satisfies

$${α}_{n} ≡ α , {φ}_{n} = - \frac{2 π {d}_{n}}{λ} ( sin {θ}_{i} + sin {θ}_{r} ) ,$$

then the reflected beam (e.g., the main lobe) may point to the direction θᵣ. However, the RIS CU 315 may select a coefficient amplitude and phase values of each meta-element (e.g., reflective element 335) from a set {(a₁, φ₁), (a₂, φ₂), . . . , (a_{M}, φ_{M})} according to different configurations, such that an actual beam shape may deviate from a calculated beam shape. The set of different configurations may be a limited set of configurations (e.g., 4, 8, or 16 configuration options), each configuration associated with a particular phase shift and magnitude response for a RIS 305. The number of reflective elements 335 at the RIS 305 may be directly proportional to the accuracy of the beam shape and direction.

In some other examples, if the transmitter or receiver lie in the near-field of the surface of the RIS 305, the incident angles θ_{i,n} or reflected angles θ_{r,n} of multiple meta-elements (e.g., reflective elements 335) may be different. The incident angles θ_{i,n} and reflected angles θ_{r,m}, between the transmitter, receiver, or both and the nth reflective element 335, d_{i,n} and d_{r,n}, respectively, may be calculated based on the position of the reflective element 335, the orientation of the RIS 305, and the position of the transmitter, receiver, or both relative to the RIS 305. Thus, the network entity 105-a may select a coefficient amplitude and phase, αₙ and φₙ, of each reflective element 335 in relation to the incident angles θ_{i,n} or reflected angles θ_{r,n}, which depend on both the direction and distance of the transmitter and receiver relative to the RIS 305. When the transmitter (e.g., the network entity 105-a, the UE 115-a, or both) sends a signal toward an nth reflective element 335 at an incident angle θ_{i,n} and a distance d_{i,n}, the equivalent channel response value of the nth reflective element 335 of the RIS 305 at a reflection angle θ_{r,n} and a distance d_{r,n}, may be calculated according to Equation 3:

$${h}_{n} = {e}^{j \frac{2 π ( ( {d}_{i , n} - {d}_{i , 0} ) + ( {d}_{r , n} - {d}_{r , 0} ) )}{λ}} \cdot {α}_{n} {e}^{j {φ}_{n}} \qquad ( 3 )$$

Similarly, the overall equivalent channel response value of all of the reflective elements 335 of RIS at a reflection angle θ_{r,n} and a distance d_{r,n} may be calculated according to Equation 4:

$$h = {\sum }_{n = 0}^{N - 1} {h}_{n} = {\sum }_{n = 0}^{N - 1} {e}^{j \frac{2 π ( ( {d}_{i , {n}^{-}} {d}_{i , 0} ) + ( {d}_{r , n} - {d}_{r , 0} ) )}{λ}} \cdot {α}_{n} {e}^{j {φ}_{n}} \qquad ( 4 )$$

Thus, if the reflection coefficient satisfies

$${α}_{n} ≡ α , {φ}_{n} = - \frac{2 π ( ( {d}_{i , n} - {d}_{i , 0} ) + ( {d}_{r , n} - {d}_{r , 0} ) )}{λ} ,$$

then the reflected beam (e.g., the main lobe) may point to the reflection angle θ_{r,n} and the distance d_{r,n}. In practice, RIS 305 may determine αₙ and φₙ by selecting one available configuration whose amplitude and phase are the closest to the theoretical (calculated) values.

For a RIS 305, the amplitude and phase of reflection coefficients at each reflective element 335 (meta-element) may vary with frequency. The characteristics of the relationship between amplitude, phase, or both, and frequency may depend on the hardware structure of the RIS. In some examples the reflective elements 335 (meta-elements) may be implemented using a quantity of PIN diodes. In such case, the coefficient phase of each configuration may change linearly, or almost linearly, with the frequency. In other examples, the reflective elements 335 (meta-elements) may be implemented using a quantity of varactor diodes. In such case, the coefficient phase of each configuration may change non-linearly with the frequency. The coefficient amplitude may also have a variance (e.g., a relatively small variance) with frequency. In many cases, for each reflective element 335 (meta-element) configuration, the reflection coefficient amplitude and phase are frequency-dependent (Ψ(f)), which may be expressed by Equation 5:

$$Ψ ( f ) = \{ ( {a}_{1} ( f ) , {ϕ}_{1} ( f ) ) , ( {a}_{2} ( f ) , {ϕ}_{2} ( f ) ) , … , ( {a}_{M} ( f ) , {ϕ}_{M} ( f ) ) \} \qquad ( 5 )$$

where aₘ is the coefficient amplitude for the m^{th} reflective element 335 of M total reflective elements 335, and φₘ the coefficient phase for the m^{th} reflective element 335 of M total reflective elements 335.

In some applications, large-bandwidth RIS-based communication may be desirable. For example, certain applications (such as digital twin, collaborative artificial intelligence (AI), holographic video) may use high or ultra-high data rates, for example in the range of approximately 100 gigabits per second to 1 terabit per second. A large bandwidth for communication, such as a bandwidth of 500 MHz to 1 GHz, may be used for such applications. In some cases, the available large-bandwidth radio frequency spectrum can be unlicensed spectrum or (new or re-farmed) existing licensed radio frequency spectrum. RIS may be used to further increase the beamforming gain and throughput, to extend the coverage behind blockages, or to reduce the hardware cost and power consumption. In some examples, a RIS may be introduced to replace one or more large phase-shift antenna panels.

However, in some cases, a RIS 305 may have low beamforming gain for some subbands of the bandwidth (e.g., at some frequencies, bandwidths, or channels). Also, at one time occasion, a RIS may be limited to applying a single one configuration to a reflective elements 335 (meta-element) at a time. However, each different one of the reflective elements 335 (each meta-element) may have a different configuration at a same time. In some example, because of the frequency-domain variance of reflection coefficient values, as described further herein, when RIS 305 is used to reflect a large-bandwidth signal, a single configuration for each reflective elements 335 applicable across the entire operating bandwidth (e.g., a single wideband meta-element configuration) may perform poorly, for example, by not being able to achieve the maximum RIS reflection beamforming gain in all subbands of the bandwidth. For example, in some subbands, the single configuration (e.g., a selected wideband meta-element configuration applicable across all subbands) may result in the actual reflection coefficients badly matching (e.g., different by at least a threshold) the theoretical coefficients. In such case, the beamforming gain at these subbands may have great loss (e.g., a loss greater than some threshold). In such examples, low reflection beamforming gain may result at these subbands, and the overall communication throughput may decrease.

A RIS 305 may use RIS beamforming with time-division multiple meta-element (reflective element 335) configurations can be used. Each configuration may optimize the reflection beamforming gain in a certain frequency segment of the large bandwidth. The RIS CU 315, or together with RIS 305, may determine the number of used meta-element configurations, including the number of frequency segments, which may depend on the reflection coefficient frequency-domain characteristics of RIS 305.

The network entity 105-a may transmit, to a RIS CU 315, a first control message 350 indicating a frequency and a bandwidth for a carrier of a communication signal. In some examples, the network entity 105-a may also transmit in or with the first control message 350 an indication of an incident angle, reflected angle, incident position, reflected position, or any combination of these to the RIS CU 315.

The RIS CU 315 may receive the first control message 350, and identify frequency domain segments for the indicated bandwidth and frequency. Each frequency domain segment may be associated with a different configuration for the reflective elements 335. The RIS CU 315 may then transmit an indication of the quantity of frequency domain segments to the network entity 105-a via a second control message 355. In some examples, the RIS CU 315 may reports an indication of a suggested or recommended number of frequency-domain segments, and the network entity 105-a may determine and configure a proper number of frequency domain segments for RIS 305. Network entity 105-a may then provide an indication of this number to RIS CU 315 which may control RIS 305 according to the indicated number of frequency domain segments.

The network entity 105-a may then identify a set of time-frequency resources to use to communicate (uplink, downlink, or both) with the UE 115-a, where each resource of the set of time-frequency resources may map a different frequency domain segment of the bandwidth to a different time occasion. During each time occasion, the RIS may use a different associated configuration for the reflective elements 335 of RIS 305. As such, the network entity 105-a may communicate with UE 115-a using different configurations for the reflective elements 335 by the RIS 305 cycling through different configurations at different time occasions that are associated with different frequency domain segments of the bandwidth. In some examples, RIS 305 may be controlled to use a particular configuration at a particular time occasion based on an implicit mapping between respective frequency domain segments and respective time occasions. In other examples, network entity 105-a may provide an indication 360 of a frequency domain segment, for example indicating, for each time occasion, a frequency domain segment that the network entity 105-a or UE 115-a is to use for that time occasion. In response, RIS 305 may use a set of corresponding configurations for the reflective elements 335.

RIS CU 315 may generate reflection coefficients for RIS 305 to aim (direct, beamform) at the direction or position of UE 115-a, and optimize reflection beamforming gain for one frequency domain segment, while the network entity 105-a may transmit data signals at the corresponding frequency-domain segment. The other frequency domain resources, excluding the frequency-domain segment used by RIS 305 in one time occasion can be used for other purposes, for example for network entity 105-a to transmit to another RIS or UE 115.

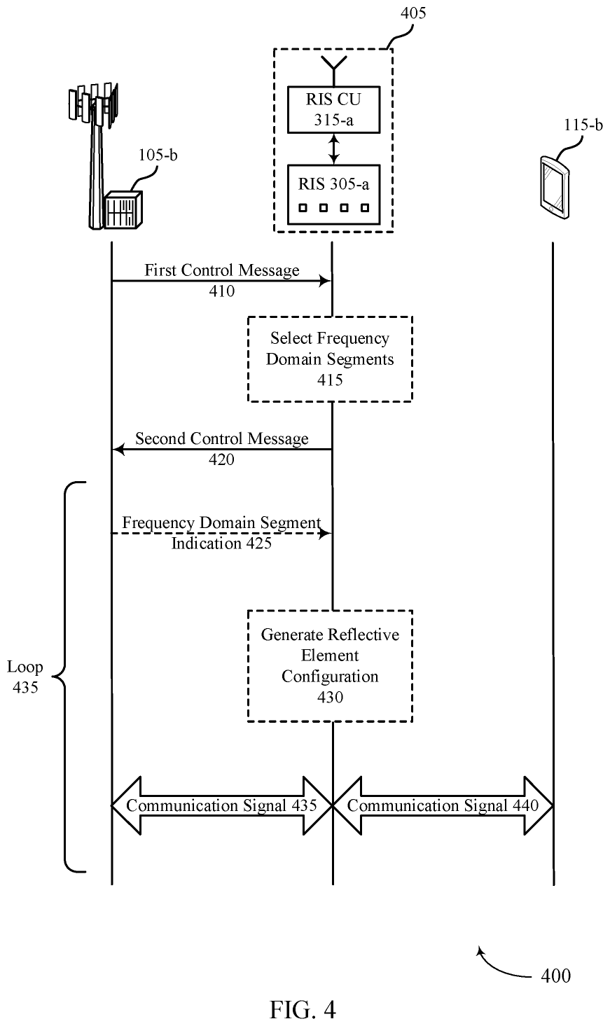

FIG. 4 illustrates an example of a process flow 400 that supports large-bandwidth RIS communication in accordance with one or more aspects of the present disclosure. The process flow 400 may implement or be implemented to realize aspects of the wireless communications system 100, network architecture 200, or wireless communications system 300. For example, the process flow 400 illustrates communication between a UE 115-b and a network entity 105-b via a RIS 305-a, which may be examples of corresponding devices described herein, including with reference to FIG. 1, FIG. 2, FIG. 3, or a combination thereof. In some cases, the UE 115-b and the network entity 105-b may establish communications via the RIS 305-a, at least in part based on control messages exchanged on a communication link between network entity 105-b and a RIS CU 315-a that controls RIS 305-a.

As further described herein, the term “RIS” may be used to refer to a device that includes one or more reflective elements, such as RIS 305-a, that is controlled by a RIS CU 315-a. Additionally, or alternatively, the term “RIS” may refer to the combination of the RIS CU 315-a and the RIS 305-a that includes the one or more reflective elements. As such, RIS 405 may refer to the RIS CU 315-a individually, or the combination of the RIS CU 315-a and the RIS 305-a. Similarly, RIS 405 may refer to the RIS 305-a individually, or the combination of the RIS CU 315-a and the RIS 305-a.

The network entity 105-b may transmit a first control message 410 to RIS 405 (e.g., RIS CU 315-a), and RIS 405 may receive the first control message (e.g., at RIS CU 315-a). In some example the first control message may be or indicate a configuration (carrier configuration). For example, in a RIS-based communication system, a network entity 105-b (e.g., a gNB or DU) may indicate (e.g., via a configuration to configure) the frequency (carrier frequency) and bandwidth (carrier bandwidth) of a carrier of a communication signal. If target UE 115-b is in far field or near field of RIS 405, network entity 105-b may indicate the reflection angle or position associated with this UE 115-b. The first control message 410 may be via RRC signaling, a MAC control element (CE), downlink control information (DCI), or a combination of two or more of these (e.g., RRC signaling and DCI, or two MAC CEs). The indication may be explicit or implicit.

In some examples, the first control message may also indicate an incident angle, reflection angle, or both, to RIS 405. As further described herein, the incident angle may represent the angle associated with the carrier incident to the RIS 405, such as specifically incident to the plane containing the reflective elements of the RIS 405. For example, the incident angle may be from the network entity 105-b (for downlink), UE 115-b (for uplink), or both, with respect to a normal vector to the plane of the RIS containing the reflective elements. Also as further described herein, the reflected angle may represent the angle associated with the carrier reflected from the RIS 405, such as specifically reflected from the plane containing the reflective elements of the RIS 405. For example, the reflected angle may be from RIS 405 toward the network entity 105-b (for uplink), from RIS 405 toward UE 115-b (for downlink), or both, with respect to a normal vector to the plane of the RIS containing the reflective elements. The first control message 410 may indicate the incident angle and reflected angle as a tuple for downlink, a tuple for uplink, or both.

Additionally, or alternatively, the first control message may indicate an incident position, reflected position, or both, to RIS 405. As further described herein, the incident position may represent the position (e.g., relative to RIS 405) of network entity 105-b (for downlink), UE 115-b (for uplink), or both. Also as further described herein, the reflected position may represent the position (e.g., relative to RIS 405) of network entity 105-b (for uplink), UE 115-b (for downlink), or both. The first control message 410 may indicate the incident position and reflected position as a tuple for downlink, a tuple for uplink, or both.

In some examples, RIS 405 may identify (e.g., determine, identify, calculate) the incident angle, reflection angle, or both by beam sweeping. For example RIS 405 may reflect (or transmit) a reference signal over multiple different directions (e.g., over multiple different time durations) using different configurations of reflective elements to determine an angle associated with network entity 105-b, UE 115-b, or both. In some examples, RIS 405 may provide a result of the beam sweep to network entity 105-b, or use the result to select or otherwise determine the frequency domain segments at 415.

At 415, RIS 405 (e.g., RIS CU 315-a) may optionally select the frequency domain segments, as further described herein. For example RIS 405 may determine (identify, select, generate) frequency-domain segments (e.g., a number of frequency-domain segments) based on the first control message 410 (e.g., based on the received configuration). In some examples, the RIS 405 may determine the frequency-domain segments based at least in part on the reflective element (meta-element) reflection coefficients frequency-domain characteristics for RIS 405.

In some examples, the RIS 405 may divide (e.g., segment or allocate) the bandwidth evenly in frequency into two or more segments (e.g., frequency domain segments) resulting in a set of frequency domain segments. For example, the RIS 405 may divide the bandwidth based on a certain number of segments (e.g., preconfigured at RIS 405, configured by network entity 105-b, or selected by RIS 405), for example four, or eight. As another example, the RIS 405 may divide the bandwidth based on a certain frequency bandwidth size, such as a band, subband, channel, or subchannel size (e.g., preconfigured at RIS 405, configured by network entity 105-b, or selected by RIS 405), for example, 20, 50, or 80 MHz. In some examples, the RIS 405 may segment or allocate the bandwidth into a single segment, for example where the frequency bandwidth size is equal to or greater than the bandwidth.

In other examples, the RIS 405 may divide (e.g., segment or allocate) the bandwidth unevenly in frequency into two or more segments (e.g., frequency domain segments).

The RIS 405 (e.g., RIS CU 315-a) may transmit a second control message 420 to network entity 105-b. For example, the RIS 405 may transmit (e.g., report) the number of frequency-domain segments to the network entity 105-b (e.g., gNB or DU) that is based on the first control message 410 (e.g., according to a configuration identified from first control message 410). For example, in the case where the frequency domain segments are evenly allocated across the bandwidth of the carrier, the second control message 420 may indicate a number (e.g., quantity) of frequency domain segments for the bandwidth. In some examples, the indication may be via an integer, a flag, or enumerated via a bitmap (e.g., referencing a table). As another example, in the case where the frequency domain segments are unevenly allocated across the bandwidth of the carrier, the second control message 420 may indicate a number (e.g., quantity) of frequency domain segments for the bandwidth and a frequency size associated with each frequency domain segment. In some examples, the indication may be via an integer, a flag, or enumerated via a bitmap (e.g., referencing a table). The second control message 420 may be via RRC signaling, a MAC control element (CE), uplink control information (UCI), or a combination of two or more of these (e.g., RRC signaling and UCI, or two MAC CEs). The indication may be explicit or implicit.

Based at least in part on the number (e.g., quantity) and bandwidth associated with each frequency domain segment of the set of frequency domain segments, the network entity 105-b, or a different network entity (e.g., another base station, scheduling node, or CU) associated with network entity 105-b, may determine (e.g., identify, schedule, allocate, grant) resources for communication with UE 115-b via RIS 405. For example, and as further described herein, network entity 105-b may determine a set of time occasions, where each time occasions corresponds to a respective frequency domain segment of the plurality of frequency domain segments. In some examples, one frequency domain segment may be used by network entity 105-b to communicate with UE 115-b via RIS 405 at a given time, for example such that no two frequency domain segments are used during an overlapping time occasion (time period, time duration). In one example, the network entity 105-b may communicate with UE 115-b (e.g., transmit to UE 115-b via downlink or receiver from UE 115-b via uplink), via the RIS 405 (e.g., RIS 305-a), during a first time occasion of the set of time occasions using a first frequency domain segment of the set of frequency domain segments, and the network entity 105-b may communicate with UE 115-b (e.g., transmit to UE 115-b via downlink or receiver from UE 115-b via uplink), via the RIS 405 (e.g., RIS 305-a), during a second time occasion of the set of time occasions using a second frequency domain segment of the set of frequency domain segments.

In some examples, the unused frequency domain segments may be used to communicate with other UEs 115, with or by other network entities 105, or for other communication purposes. The unused frequency domain segments may be unused during that time occasions associated with the used frequency domain segment, and used during a different time occasion of the set of time occasions. In some examples, the network entity 105-b may determine a correspondence between the frequency domain segments indicated by the second control message 420 and the set of time occasions implicitly, for example based on an order of the frequency domain segments indicated in the second control message 420, or explicitly, for example based on order information of the second control message 420 or another control message provided by RIS 405.

The network entity 105-b may optionally transmit a frequency domain segment indication 425 to RIS 405 (e.g., RIS CU 315-a). In some examples, the network entity 105-b may transmit, to the RIS 405 (e.g., RIS 305-a or RIS CU 315-a), for each time occasion of the set of time occasions, an indication of a frequency domain segment of the set of frequency domain segments to be used during the time occasion. The frequency domain segment indication 425 may be an indication (e.g., flag, bit or set of bits, or other indicator) provided via control signaling, such as RRC signaling, a MAC CE, DCI, or a combination of these. In other examples, the network entity 105-b may transmit, to the RIS 405 (e.g., RIS 305-a or RIS CU 315-a), an indication of a correspondence (e.g., mapping) between the set of time occasions and the set off frequency domain segments, for example identifying each time occasion of the set of time occasions and the respective frequency domain segment of the set of frequency domain segments. The indication may be provided implicitly (e.g., via an order of identified frequency domain segments or time occasions) or explicitly (e.g., via an indication of an order provided by the control signaling conveying the frequency domain segment indication 425.

At 430, RIS 405 (e.g., RIS CU 315-a) may optionally determine (e.g., identify, select, or generate) a configuration for one or more reflective elements of RIS 405 (e.g., RIS 305-a) for the set of time occasions. The configuration may be of a set or subset of reflective elements (e.g., meta-elements) of RIS 405 (e.g., RIS 305-a). In some examples, the RIS 405 may be capable of operating according to a configured or predefined set of configurations, and RIS 405 may select or other identify one of the set of configurations to use during a time occasion of the set of time occasions. Each time occasion may have a different associated configuration, one or more of the configurations may be the same in different time occasions, or all time occasions may use the same configuration according to the identification by RIS 405.

As further described herein, RIS 405 may generate reflection coefficients (e.g., for each reflective element, meta-element) based on a center frequency, all subcarriers' frequencies, or some set of subcarriers' frequencies of a frequency domain segment and one or more of an incident angle, reflected angle, incident position, or reflected position. For example, RIS 405 may generate reflection coefficients based on a center frequency of a frequency domain segment and one or both of an incident angle or reflected angle. In other examples, RIS 405 may generate the reflection coefficients based on a center frequency of a frequency domain segment and one or both of an incident position or reflected position. In some examples, the reflection coefficient for a frequency domain segment may be selected or otherwise determined based on a maximum reflection beamforming gain (e.g., as identified by the receiving device, such as network entity 105-b or UE 115-b). In other examples, the reflection coefficient for a frequency domain segment may be selected or otherwise determined based on the gain satisfying a threshold gain.

In some examples, for each time occasion, RIS 405 determines the configuration of reflective elements (e.g., meta-elements) based on the center frequency (or all the involved subcarriers' frequencies) of the associated frequency-domain segment, the incident/reflection angle/position of UE, and the RIS meta-element reflection coefficient frequency characteristics, so that the RIS reflection beamforming gain can be maximized for the used frequency segment at each time occasion.

During a set of time occasions, RIS 405 may control a set of reflective elements of the RIS to reflect a communication signal (including incident and reflected portions, such as a communication signal 435 between network entity 105-b and RIS 405 and communication signal 440 between UE 115-b and RIS 405) according to the set of frequency domain segments, where each time occasion of the set of time occasions corresponds to a respective frequency domain segment of the set of frequency domain segments. For example, during each time occasion, the network entity 105-b may communicate with UE 115-b via the RIS 405 (e.g., RIS 305-a) using a frequency domain segment associated with the time occasion according to a configuration of reflective elements of RIS 405 corresponding to the frequency domain segment. For the time occasion, RIS 405 may control a set of reflective elements. Communication signal 435 may be incident on RIS 405 for downlink, and communication signal 440 may be reflected from RIS 405 for downlink. Communication signal 440 may be incident on RIS 405 for uplink, and communication signal 435 may be reflected from RIS 405 for uplink.

Optionally, in some examples, a time occasion may include a frequency domain segment indication 425, generating reflective element configuration at 430 associated with the indicated frequency domain segment, and communication signal 435 and communication signal 440, which may be a loop 435 repeated for each time occasion of a set of time occasions.

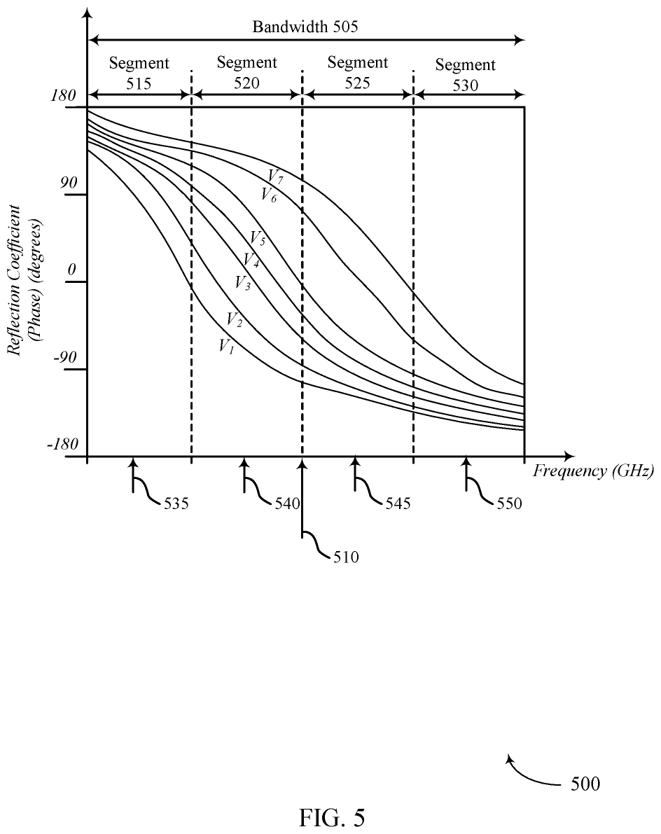

FIG. 5 illustrates an example of a frequency domain segmentation 500 that supports large-bandwidth RIS communication in accordance with one or more aspects of the present disclosure.

Frequency domain segmentation 500 may be or include aspects of a RIS 405 selecting frequency domain segments at 410 of process flow 400. Frequency domain segmentation 500 includes an x-axis of frequency in GHz and reflection coefficient (phase) associated with a reflective element of a RIS in degrees.

Bandwidth 405 may be an example of a bandwidth for a carrier, for example indicated in first control message 410 transmitted by network entity 105-b. Segment 515, segment 520, segment 525, segment 530 may be examples of frequency domain segments, for example selected frequency domain segments at 410. Frequency 510 may be an example of a frequency for a carrier, for example indicated in first control message 410 transmitted by network entity 105-b. Frequency 535, frequency 540, frequency 545, and frequency 550 are center frequencies of segment 515, segment 520, segment 525, segment 530, respectively, and may be examples of center frequencies of selected frequency domain segments at 410.

In one example, RIS reflection coefficient frequency-domain characteristics may be used, where the network entity (e.g., a gNB) configures the RIS with a bandwidth and frequency for a carrier. In one example, bandwidth 505 may be 1.2 GHz and frequency 510 may be 5.8 GHz. Other values for bandwidth 505, frequency 510, and M may be used consistent with the techniques described herein. Frequency domain segmentation 500 shows example curves of reflection coefficient (phase) versus frequency for reflective elements of a RIS for different voltages (e.g., V₁ through V₇, such that M=7) applied to reflective elements of a RIS (e.g., for a varactor diode-based RIS). Each different applied voltage may correspond to a different configuration for the reflective element or elements. Greater or fewer than seven configuration may be applicable for a RIS, for example four or sixteen.

In one example, a RIS may generate the configurations (e.g., meta-element configurations) based on the carrier frequency, bandwidth, incident angle, and reflection angle, and compare different options for the frequency domain segments. In one example, the RIS may evaluate a wideband coefficient, two-segment coefficient, three-segment coefficient, four segment coefficient (e.g., as illustrated with segment 515, segment 520, segment 525, segment 530), and so on.

In another example, the RIS, to optimize the reflection beamforming gain at each frequency domain segment, RIS may use a quantity of frequency domain segments (e.g., N=4 for segment 515, segment 520, segment 525, segment 530), which may be unevenly-distributed in frequency. The RIS may assume the center frequencies of each segment are

$${\{ {f}_{n} \}}_{n = 1}^{N} .$$

In the example of frequency domain segmentation 500, N=4, such that frequency 535, frequency 540, frequency 545, and frequency 550 are center frequencies of segment 515, segment 520, segment 525, segment 530, respectively. Each (the mth) configuration has different amplitudes and phases at each fₙ, denoted as {α_{m,n}φ_{m,n}}_{m=1˜M,n=1˜N}. For segment n, the RIS may determine the configuration of each reflective element (meta-element) based on the {α_{m,n},φ_{m,n}}, the incident angle, the reflection angle, and another parameter. In one example, the another parameter may be the aggregation of the reflected signals from all the reflective element (e.g. meta-elements) that has the largest power at frequency fₙ. The aggregation may be h for a far field UE or a near field UE, as further described herein, for example with reference to Equations 1 through 5. In another example, the aggregation (h) of the reflected signals from all the reflective element (e.g. meta-elements) for a far field UE or a near field UE has the largest summed power at all involved subcarriers in frequency segment n.

In another example, the relative differences between every two coefficient phases of configurations may be the same or substantially the same at all the frequencies for a RIS (e.g., Ae is a constant between the curves associated with V₁ through V₇). In such example, the optimal configuration for the carrier bandwidth 505 (e.g., a whole frequency spectrum) may be the same, and a number of frequency domain segments indicated by the RIS may be one segment.

In another example, for some {incident angle, reflection angle} pair, the optimal reflection coefficients of all reflective elements (e.g., meta-elements), may be identical or substantially the same, and thus the RIS may select the same configuration for all reflective elements (e.g., meta-elements). For example, the coefficient vector may then be [1, 1 . . . , 1]·e\hat{ }(jθ(f)) at different frequencies (e.g., subcarriers) of the bandwidth. In some example the variant phase θ(f) does not impact the beamforming gain. For example, if the incident angle θᵢ and the reflection angle θᵣ satisfies θᵢ=−θᵣ (e.g., the boresight direction is 0 degrees), then the optimal reflection coefficient may always equal to 1 at all reflective elements. Expressed as an Equation 6:

$${φ}_{n} = - \frac{2 π {d}_{n}}{λ} ( sin {θ}_{i} + sin {θ}_{r} ) = 0 \qquad ( 6 )$$

In this case, the RIS may not suggest frequency domain segmentation, that is, the RIS may report the quantity of frequency domain segments as one.

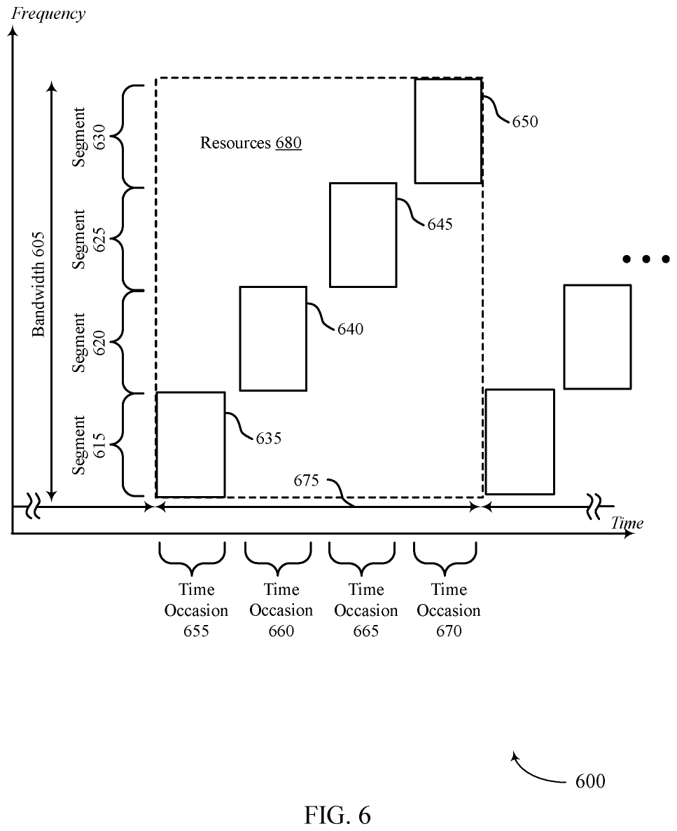

FIG. 6 illustrates an example of a resource allocation 600 that supports large-bandwidth RIS communication in accordance with one or more aspects of the present disclosure. Resource allocation 600 may be a resource allocation used as part of communications between a network entity 105 and UE 115 via a RIS (e.g., RIS 305, RIS 405), and may be uplink, downlink, or both.

Resource allocation 600 may include a set of resources spanning a bandwidth 605 for a carrier that is to be used to communicate with a UE, including resource 635, resource 640, resource 645, and resource 650. Resource 635 may include frequency resource corresponding to frequency resource segment 615; resource 640 may include frequency resource corresponding to frequency resource segment 620; resource 645 may include frequency resource corresponding to frequency resource segment 625; and resource 650 may include frequency resource corresponding to frequency resource segment 630. Additionally, resource 635, resource 640, resource 645, and resource 650 may be associated with time occasion 655, time occasion 660, time occasion 665, and time occasion 670. A network entity may indicate resource allocation 600 to a UE with which the network entity is to communicate.

Each time occasion, time occasion 655, time occasion 660, time occasion 665, and time occasion 670, may include or be defined by a symbol or set of symbols, slot or set of slots, subframe or set of frames or subframes, or other time duration. Each time occasion of the set of time occasions may be of equal, or different, time durations. Time occasions may be sequential (e.g., in order of increasing frequency with time, or decreasing frequency with time), evenly spaced in time, irregularly spaced in time, span a time duration, or include same or different time durations between one or more pairs time occasion 655, time occasion 660, time occasion 665, and time occasion 670. In one example, time occasion 655, time occasion 660, time occasion 665, and time occasion 670 may be associated with a time duration 675, which may be a period that may repeat at a regular interval over one or more repetitions. In other examples, the use of a single instance of the set of time occasions time occasion 655, time occasion 660, time occasion 665, and time occasion 670 may be triggered by the network entity, for example, by a MAC CE, or DCI, scheduling downlink or uplink resources (e.g., providing a downlink grant or uplink grant) to a UE over the set of time occasions.

Resources 680 may be a remaining set of time-frequency resources that span bandwidth 605 and time duration 675, excluding resource 635, resource 640, resource 645, and resource 650. In some examples, resources 680 may be the remaining set of time-frequency resources that span bandwidth 605 and time occasion 655, time occasion 660, time occasion 665, and time occasion 670, excluding resource 635, resource 640, resource 645, and resource 650. Resources 680 may be unused radio resources, for example in each time occasion, that is available to the network entity for other purposes. For example the network entity may transmit to one or more network entities or other UEs, directly or via a different RIS than the RIS associated with resource 635, resource 640, resource 645, and resource 650.

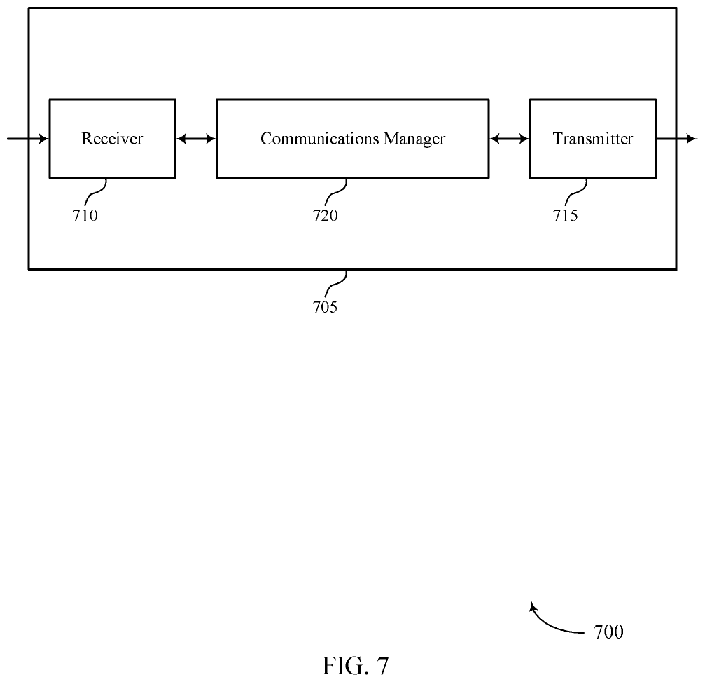

FIG. 7 shows a block diagram 700 of a device 705 that supports large-bandwidth RIS communication in accordance with one or more aspects of the present disclosure. The device 705 may be an example of aspects of a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations thereof or various components thereof may be examples of means for performing various aspects of large-bandwidth RIS communication as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a network entity in accordance with examples as disclosed herein. For example, the communications manager 720 may be configured as or otherwise support a means for transmitting, to a RIS, a first control message indicating a frequency and a bandwidth for a carrier of a communication signal. The communications manager 720 may be configured as or otherwise support a means for receiving, from the RIS at least in part in response to the first control message, a second control message identifying a quantity for a set of multiple frequency domain segments for the bandwidth of the communication signal. The communications manager 720 may be configured as or otherwise support a means for communicating, via the RIS for each frequency domain segment of the set of multiple frequency domain segments, the communication signal on the frequency domain segment during a time occasion of a set of multiple time occasions, each time occasion of the set of multiple time occasions corresponding to a respective frequency domain segment of the set of multiple frequency domain segments.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for large-bandwidth RIS communications. These techniques may result in an increase in reflection beamforming gain relative to use of a uniform configuration of reflective elements at the RIS over a full bandwidth (e.g., a wideband coefficient). An increase reflection beamforming gain may result in a higher signal to interference noise ratio (SINR) at the receiver (UE for downlink, network entity for uplink), higher throughput, improved communications reliability, and an improved user experience.

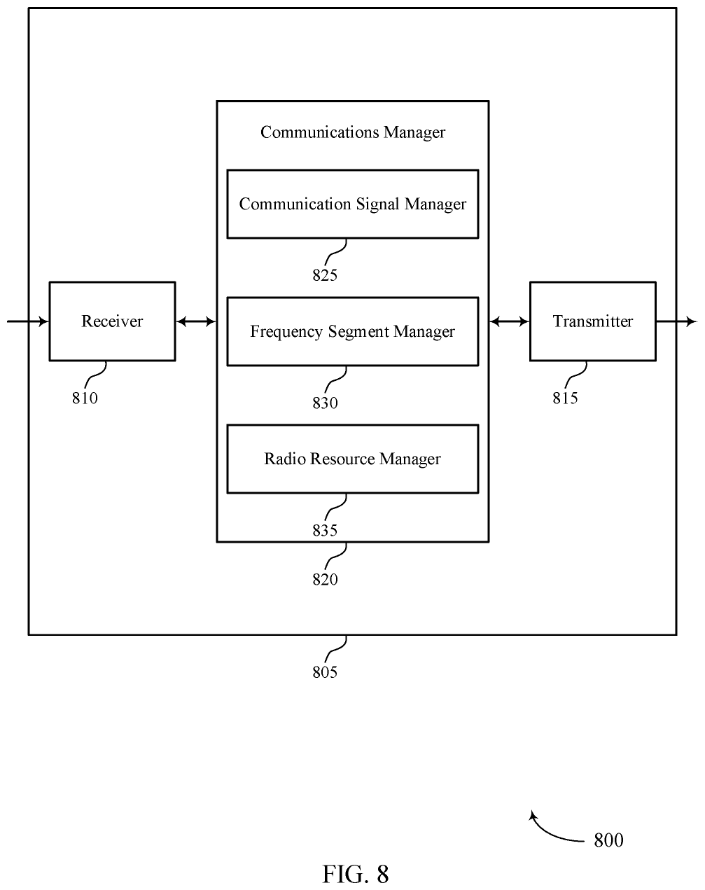

FIG. 8 shows a block diagram 800 of a device 805 that supports large-bandwidth reconfigurable intelligent surface communication in accordance with one or more aspects of the present disclosure. The device 805 may be an example of aspects of a device 705 or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of large-bandwidth reconfigurable intelligent surface communication as described herein. For example, the communications manager 820 may include a communication signal manager 825, a frequency segment manager 830, a radio resource manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity in accordance with examples as disclosed herein. The communication signal manager 825 may be configured as or otherwise support a means for transmitting, to a reconfigurable intelligent surface (RIS), a first control message indicating a frequency and a bandwidth for a carrier of a communication signal. The frequency segment manager 830 may be configured as or otherwise support a means for receiving, from the RIS at least in part in response to the first control message, a second control message identifying a quantity for a set of multiple frequency domain segments for the bandwidth of the communication signal. The radio resource manager 835 may be configured as or otherwise support a means for communicating, via the RIS for each frequency domain segment of the set of multiple frequency domain segments, the communication signal on the frequency domain segment during a time occasion of a set of multiple time occasions, each time occasion of the set of multiple time occasions corresponding to a respective frequency domain segment of the set of multiple frequency domain segments.

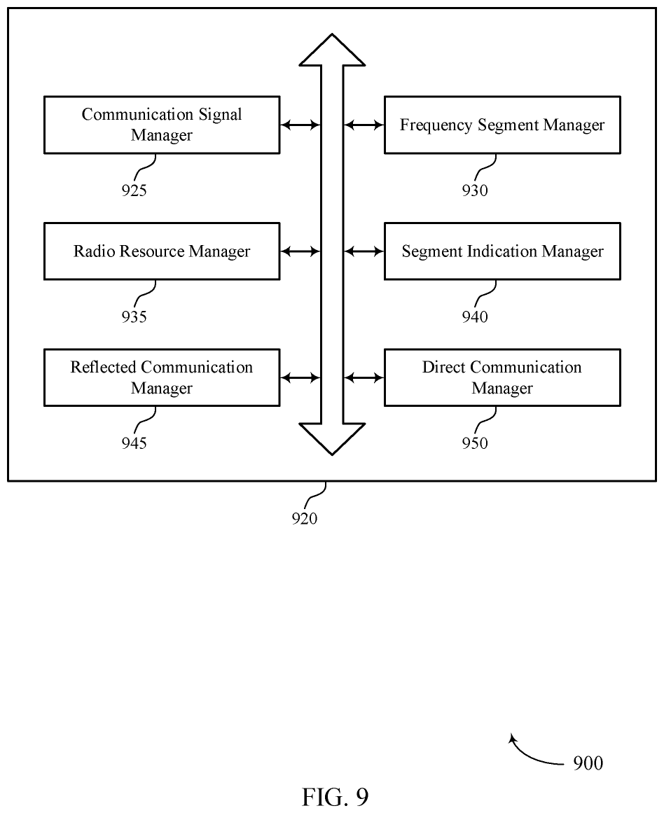

FIG. 9 shows a block diagram 900 of a communications manager 920 that supports large-bandwidth reconfigurable intelligent surface communication in accordance with one or more aspects of the present disclosure. The communications manager 920 may be an example of aspects of a communications manager 720, a communications manager 820, or both, as described herein. The communications manager 920, or various components thereof, may be an example of means for performing various aspects of large-bandwidth reconfigurable intelligent surface communication as described herein. For example, the communications manager 920 may include a communication signal manager 925, a frequency segment manager 930, a radio resource manager 935, a segment indication manager 940, a reflected communication manager 945, a direct communication manager 950, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communication at a network entity in accordance with examples as disclosed herein. The communication signal manager 925 may be configured as or otherwise support a means for transmitting, to a reconfigurable intelligent surface (RIS), a first control message indicating a frequency and a bandwidth for a carrier of a communication signal. The frequency segment manager 930 may be configured as or otherwise support a means for receiving, from the RIS at least in part in response to the first control message, a second control message identifying a quantity for a set of multiple frequency domain segments for the bandwidth of the communication signal. The radio resource manager 935 may be configured as or otherwise support a means for communicating, via the RIS for each frequency domain segment of the set of multiple frequency domain segments, the communication signal on the frequency domain segment during a time occasion of a set of multiple time occasions, each time occasion of the set of multiple time occasions corresponding to a respective frequency domain segment of the set of multiple frequency domain segments.

In some examples, to support transmitting the first control message, the communication signal manager 925 may be configured as or otherwise support a means for transmitting, to the RIS, an indication of an incident angle of the communication signal at the RIS, an indication of a reflection angle for the communication signal at the RIS, or both.

In some examples, to support transmitting the first control message, the communication signal manager 925 may be configured as or otherwise support a means for transmitting, to the RIS, an indication of position information for the communication signal that is incident at the RIS, an indication of position information for the communication signal that is reflected from the RIS, or both.

In some examples, to support receiving the second control message, the frequency segment manager 930 may be configured as or otherwise support a means for receiving an indication of the quantity of the set of multiple the frequency domain segments, where each of the set of multiple frequency domain segments are evenly allocated in the bandwidth.

In some examples, to support receiving the second control message, the frequency segment manager 930 may be configured as or otherwise support a means for receiving an indication of the quantity of the set of multiple the frequency domain segments and a respective bandwidth for each frequency domain segment of the frequency domain segments.

In some examples, at least one of the set of multiple frequency domain segments are unevenly allocated in the bandwidth.

In some examples, the segment indication manager 940 may be configured as or otherwise support a means for transmitting, to the RIS for each time occasion of the set of multiple time occasions, an indication of a frequency domain segment of the set of multiple frequency domain segments to be used during the time occasion.

In some examples, the segment indication manager 940 may be configured as or otherwise support a means for transmitting, to the RIS, an indication of a correspondence between each time occasion of the set of multiple time occasions and the respective frequency domain segment of the set of multiple frequency domain segments.

In some examples, the second control message includes a set of multiple indicators corresponding to the set of multiple frequency domain segments, and the frequency segment manager 930 may be configured as or otherwise support a means for determining a correspondence between each time occasion of the set of multiple time occasions and the respective frequency domain segment of the set of multiple frequency domain segments based on an order of the set of multiple indicators within the second control message.

In some examples, the reflected communication manager 945 may be configured as or otherwise support a means for communicating, via the RIS, with a first UE during a first time occasion of the set of multiple time occasions using a first frequency domain segment of the set of multiple frequency domain segments. In some examples, the direct communication manager 950 may be configured as or otherwise support a means for communicating with a second UE during the first time occasion using a second frequency domain segment of the set of multiple frequency domain segments at least in part in response to the first control message.

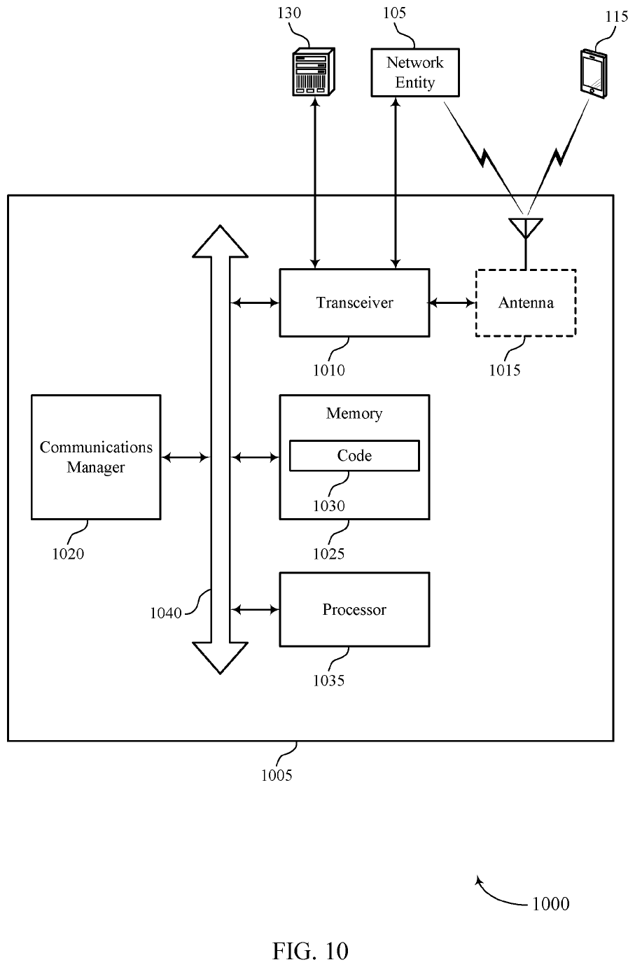

FIG. 10 shows a diagram of a system 1000 including a device 1005 that supports large-bandwidth reconfigurable intelligent surface communication in accordance with one or more aspects of the present disclosure. The device 1005 may be an example of or include the components of a device 705, a device 805, or a network entity 105 as described herein. The device 1005 may communicate with one or more network entities 105, one or more UEs 115, or any combination thereof, which may include communications over one or more wired interfaces, over one or more wireless interfaces, or any combination thereof. The device 1005 may include components that support outputting and obtaining communications, such as a communications manager 1020, a transceiver 1010, an antenna 1015, a memory 1025, code 1030, and a processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or memory components (for example, the processor 1035, or the memory 1025, or both), may be included in a chip or chip assembly that is installed in the device 1005. In some examples, the transceiver may be operable to support communications via one or more communications links (e.g., a communication link 125, a backhaul communication link 120, a midhaul communication link 162, a fronthaul communication link 168).

The memory 1025 may include RAM and ROM. The memory 1025 may store computer-readable, computer-executable code 1030 including instructions that, when executed by the processor 1035, cause the device 1005 to perform various functions described herein. The code 1030 may be stored in a non-transitory computer-readable medium such as system memory or another type of memory. In some cases, the code 1030 may not be directly executable by the processor 1035 but may cause a computer (e.g., when compiled and executed) to perform functions described herein. In some cases, the memory 1025 may contain, among other things, a BIOS which may control basic hardware or software operation such as the interaction with peripheral components or devices.

The processor 1035 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1035 may be configured to operate a memory array using a memory controller. In some other cases, a memory controller may be integrated into the processor 1035. The processor 1035 may be configured to execute computer-readable instructions stored in a memory (e.g., the memory 1025) to cause the device 1005 to perform various functions (e.g., functions or tasks supporting large-bandwidth reconfigurable intelligent surface communication). For example, the device 1005 or a component of the device 1005 may include a processor 1035 and memory 1025 coupled with the processor 1035, the processor 1035 and memory 1025 configured to perform various functions described herein. The processor 1035 may be an example of a cloud-computing platform (e.g., one or more physical nodes and supporting software such as operating systems, virtual machines, or container instances) that may host the functions (e.g., by executing code 1030) to perform the functions of the device 1005. The processor 1035 may be any one or more suitable processors capable of executing scripts or instructions of one or more software programs stored in the device 1005 (such as within the memory 1025). In some implementations, the processor 1035 may be a component of a processing system. A processing system may generally refer to a system or series of machines or components that receives inputs and processes the inputs to produce a set of outputs (which may be passed to other systems or components of, for example, the device 1005). For example, a processing system of the device 1005 may refer to a system including the various other components or subcomponents of the device 1005, such as the processor 1035, or the transceiver 1010, or the communications manager 1020, or other components or combinations of components of the device 1005. The processing system of the device 1005 may interface with other components of the device 1005, and may process information received from other components (such as inputs or signals) or output information to other components. For example, a chip or modem of the device 1005 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1005 may transmit information output from the chip or modem. Additionally, or alternatively, in some implementations, the one or more interfaces may refer to an interface between the processing system of the chip or modem and a receiver, such that the device 1005 may obtain information or signal inputs, and the information may be passed to the processing system. A person having ordinary skill in the art will readily recognize that a first interface also may obtain information or signal inputs, and a second interface also may output information or signal outputs.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the memory 1025, the code 1030, and the processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with other network entities 105, and may include a controller or scheduler for controlling communications with UEs 115 in cooperation with other network entities 105. In some examples, the communications manager 1020 may support an X2 interface within an LTE/LTE-A wireless communications network technology to provide communication between network entities 105.

The communications manager 1020 may support wireless communication at a network entity in accordance with examples as disclosed herein. For example, the communications manager 1020 may be configured as or otherwise support a means for transmitting, to a RIS, a first control message indicating a frequency and a bandwidth for a carrier of a communication signal. The communications manager 1020 may be configured as or otherwise support a means for receiving, from the RIS at least in part in response to the first control message, a second control message identifying a quantity for a set of multiple frequency domain segments for the bandwidth of the communication signal. The communications manager 1020 may be configured as or otherwise support a means for communicating, via the RIS for each frequency domain segment of the set of multiple frequency domain segments, the communication signal on the frequency domain segment during a time occasion of a set of multiple time occasions, each time occasion of the set of multiple time occasions corresponding to a respective frequency domain segment of the set of multiple frequency domain segments.

By including or configuring the communications manager 1020 in accordance with examples as described herein, the device 1005 may support techniques for large-bandwidth RIS communications. These techniques may result in an increase in reflection beamforming gain relative to use of a uniform configuration of reflective elements at the RIS over a full bandwidth (e.g., a wideband coefficient). An increase reflection beamforming gain may result in a higher SINR at the receiver (UE for downlink, network entity for uplink), higher throughput, improved communications reliability, and an improved user experience.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, the processor 1035, the memory 1025, the code 1030, or any combination thereof. For example, the code 1030 may include instructions executable by the processor 1035 to cause the device 1005 to perform various aspects of large-bandwidth reconfigurable intelligent surface communication as described herein, or the processor 1035 and the memory 1025 may be otherwise configured to perform or support such operations.

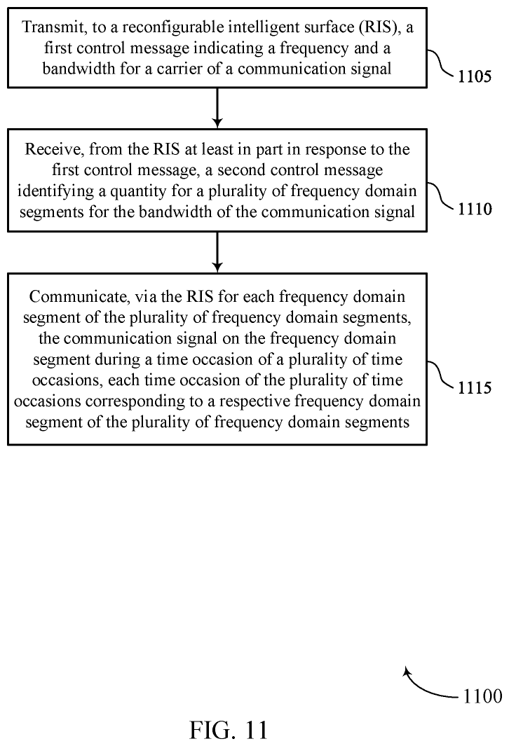

FIG. 11 shows a flowchart illustrating a method 1100 that supports large-bandwidth reconfigurable intelligent surface communication in accordance with one or more aspects of the present disclosure. The operations of the method 1100 may be implemented by a network entity or its components as described herein. For example, the operations of the method 1100 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1105, the method may include transmitting, to a reconfigurable intelligent surface (RIS), a first control message indicating a frequency and a bandwidth for a carrier of a communication signal. The operations of 1105 may be performed in accordance with examples as disclosed herein. In some examples, aspects of the operations of 1105 may be performed by a communication signal manager 925 as described with reference to FIG. 9.

At 1110, the method may include receiving, from the RIS at least in part in response to the first control message, a second control message identifying a quantity for a set of multiple frequency domain segments for the bandwidth of the communication signal. The operations of 1110 may be performed in accordance with examples as disclosed herein. In some examples, aspects of the operations of 1110 may be performed by a frequency segment manager 930 as described with reference to FIG. 9.

At 1115, the method may include communicating, via the RIS for each frequency domain segment of the set of multiple frequency domain segments, the communication signal on the frequency domain segment during a time occasion of a set of multiple time occasions, each time occasion of the set of multiple time occasions corresponding to a respective frequency domain segment of the set of multiple frequency domain segments. The operations of 1115 may be performed in accordance with examples as disclosed herein. In some examples, aspects of the operations of 1115 may be performed by a radio resource manager 935 as described with reference to FIG. 9.

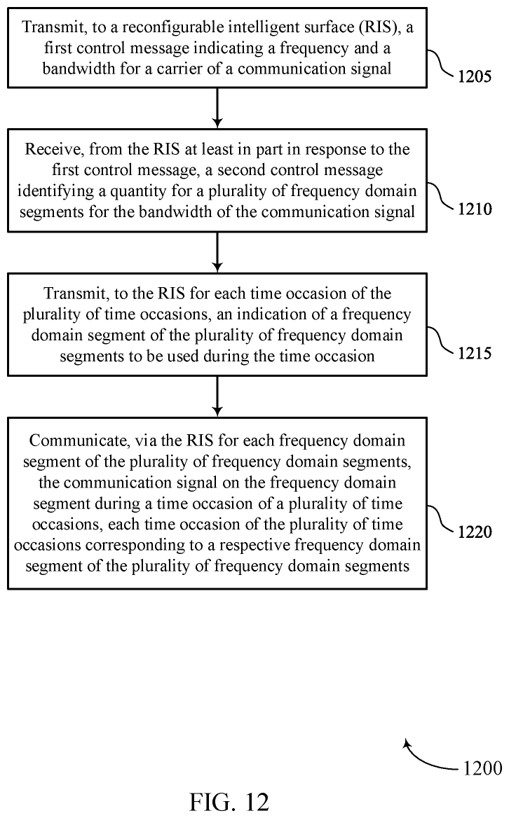

FIG. 12 shows a flowchart illustrating a method 1200 that supports large-bandwidth reconfigurable intelligent surface communication in accordance with one or more aspects of the present disclosure. The operations of the method 1200 may be implemented by a network entity or its components as described herein. For example, the operations of the method 1200 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1205, the method may include transmitting, to a reconfigurable intelligent surface (RIS), a first control message indicating a frequency and a bandwidth for a carrier of a communication signal. The operations of 1205 may be performed in accordance with examples as disclosed herein. In some examples, aspects of the operations of 1205 may be performed by a communication signal manager 925 as described with reference to FIG. 9.

At 1210, the method may include receiving, from the RIS at least in part in response to the first control message, a second control message identifying a quantity for a set of multiple frequency domain segments for the bandwidth of the communication signal. The operations of 1210 may be performed in accordance with examples as disclosed herein. In some examples, aspects of the operations of 1210 may be performed by a frequency segment manager 930 as described with reference to FIG. 9.

At 1215, the method may include transmitting, to the RIS for each time occasion of the set of multiple time occasions, an indication of a frequency domain segment of the set of multiple frequency domain segments to be used during the time occasion. The operations of 1215 may be performed in accordance with examples as disclosed herein. In some examples, aspects of the operations of 1215 may be performed by a segment indication manager 940 as described with reference to FIG. 9.

At 1220, the method may include communicating, via the RIS for each frequency domain segment of the set of multiple frequency domain segments, the communication signal on the frequency domain segment during a time occasion of a set of multiple time occasions, each time occasion of the set of multiple time occasions corresponding to a respective frequency domain segment of the set of multiple frequency domain segments. The operations of 1220 may be performed in accordance with examples as disclosed herein. In some examples, aspects of the operations of 1220 may be performed by a radio resource manager 935 as described with reference to FIG. 9.

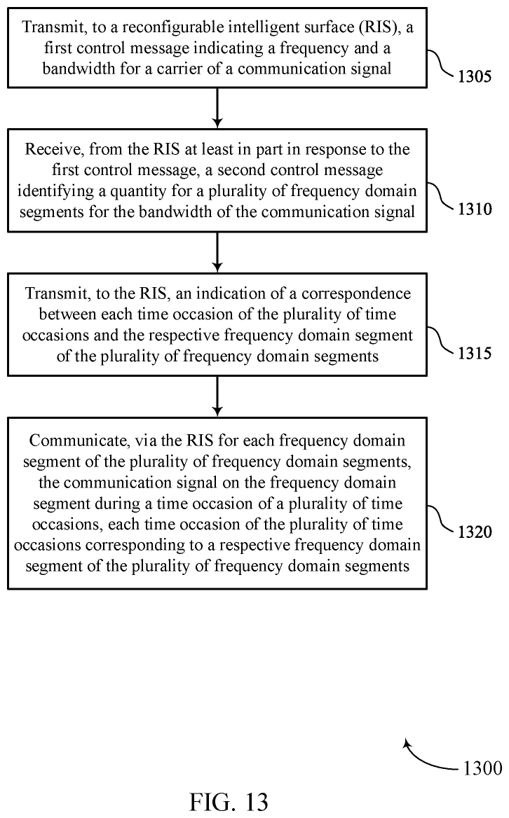

FIG. 13 shows a flowchart illustrating a method 1300 that supports large-bandwidth reconfigurable intelligent surface communication in accordance with one or more aspects of the present disclosure. The operations of the method 1300 may be implemented by a network entity or its components as described herein. For example, the operations of the method 1300 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1305, the method may include transmitting, to a reconfigurable intelligent surface (RIS), a first control message indicating a frequency and a bandwidth for a carrier of a communication signal. The operations of 1305 may be performed in accordance with examples as disclosed herein. In some examples, aspects of the operations of 1305 may be performed by a communication signal manager 925 as described with reference to FIG. 9.

At 1310, the method may include receiving, from the RIS at least in part in response to the first control message, a second control message identifying a quantity for a set of multiple frequency domain segments for the bandwidth of the communication signal. The operations of 1310 may be performed in accordance with examples as disclosed herein. In some examples, aspects of the operations of 1310 may be performed by a frequency segment manager 930 as described with reference to FIG. 9.

At 1315, the method may include transmitting, to the RIS, an indication of a correspondence between each time occasion of the set of multiple time occasions and the respective frequency domain segment of the set of multiple frequency domain segments. The operations of 1315 may be performed in accordance with examples as disclosed herein. In some examples, aspects of the operations of 1315 may be performed by a segment indication manager 940 as described with reference to FIG. 9.

At 1320, the method may include communicating, via the RIS for each frequency domain segment of the set of multiple frequency domain segments, the communication signal on the frequency domain segment during a time occasion of a set of multiple time occasions, each time occasion of the set of multiple time occasions corresponding to a respective frequency domain segment of the set of multiple frequency domain segments. The operations of 1320 may be performed in accordance with examples as disclosed herein. In some examples, aspects of the operations of 1320 may be performed by a radio resource manager 935 as described with reference to FIG. 9.

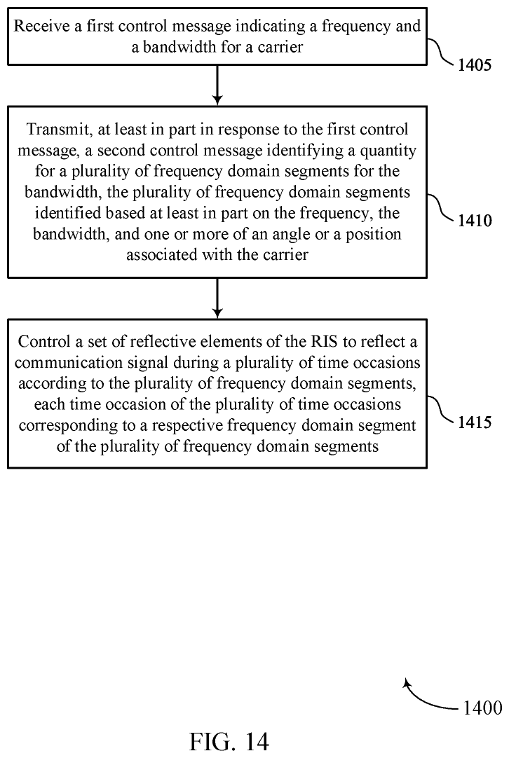

FIG. 14 shows a flowchart illustrating a method 1400 that supports large-bandwidth reconfigurable intelligent surface communication in accordance with one or more aspects of the present disclosure. The operations of the method 1400 may be implemented by a RIS or its components (e.g., a RIS CU or RIS, including reflective elements) as described herein. For example, the operations of the method 1400 may be performed by a RIS CU 315, RIS 305, or RIS 405. In some examples, the RIS CU 315 or RIS 405 may execute a set of instructions to control the functional elements of RIS 305 or RIS 405 to perform the described functions. Additionally, or alternatively, RIS CU 315 or RIS 405 may perform aspects of the described functions using special-purpose hardware, for example including a set of reflective elements.

At 1405, the method may include receiving a first control message indicating a frequency and a bandwidth for a carrier. The operations of 1405 may be performed in accordance with examples as disclosed herein.

At 1410, the method may include transmitting, at least in part in response to the first control message, a second control message identifying a quantity for a set of multiple frequency domain segments for the bandwidth, the set of multiple frequency domain segments identified based on the frequency, the bandwidth, and one or more of an angle or a position associated with the carrier. The operations of 1410 may be performed in accordance with examples as disclosed herein.

At 1415, the method may include controlling a set of reflective elements of the RIS to reflect a communication signal during a set of multiple time occasions according to the set of multiple frequency domain segments, each time occasion of the set of multiple time occasions corresponding to a respective frequency domain segment of the set of multiple frequency domain segments. The operations of 1415 may be performed in accordance with examples as disclosed herein.

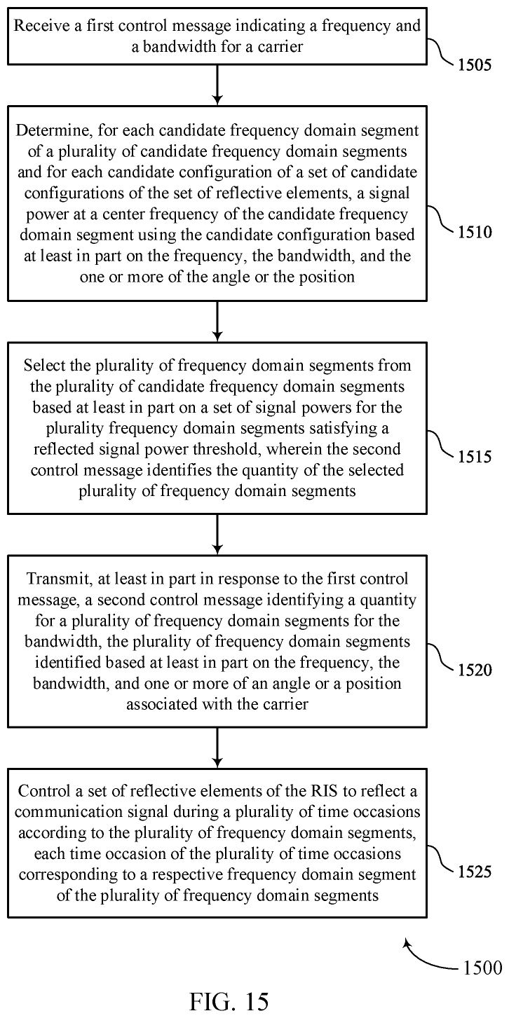

FIG. 15 shows a flowchart illustrating a method 1500 that supports large-bandwidth reconfigurable intelligent surface communication in accordance with one or more aspects of the present disclosure. The operations of the method 1500 may be implemented by a RIS or its components (e.g., a RIS CU or RIS, including reflective elements) as described herein. For example, the operations of the method 1500 may be performed by a RIS CU 315, RIS 305, or RIS 405. In some examples, the RIS CU 315 or RIS 405 may execute a set of instructions to control the functional elements of RIS 305 or RIS 405 to perform the described functions. Additionally, or alternatively, RIS CU 315 or RIS 405 may perform aspects of the described functions using special-purpose hardware, for example including a set of reflective elements.

At 1505, the method may include receiving a first control message indicating a frequency and a bandwidth for a carrier. The operations of 1505 may be performed in accordance with examples as disclosed herein.

At 1510, the method may include determining, for each candidate frequency domain segment of a set of multiple candidate frequency domain segments and for each candidate configuration of a set of candidate configurations of the set of reflective elements, a signal power at a center frequency of the candidate frequency domain segment using the candidate configuration based on the frequency, the bandwidth, and the one or more of the angle or the position. The operations of 1510 may be performed in accordance with examples as disclosed herein.

At 1515, the method may include selecting the set of multiple frequency domain segments from the set of multiple candidate frequency domain segments based on a set of signal powers for the plurality frequency domain segments satisfying a reflected signal power threshold, where the second control message identifies the quantity of the selected set of multiple frequency domain segments. The operations of 1515 may be performed in accordance with examples as disclosed herein.

At 1520, the method may include transmitting, at least in part in response to the first control message, a second control message identifying a quantity for a set of multiple frequency domain segments for the bandwidth, the set of multiple frequency domain segments identified based on the frequency, the bandwidth, and one or more of an angle or a position associated with the carrier. The operations of 1520 may be performed in accordance with examples as disclosed herein.

At 1525, the method may include controlling a set of reflective elements of the RIS to reflect a communication signal during a set of multiple time occasions according to the set of multiple frequency domain segments, each time occasion of the set of multiple time occasions corresponding to a respective frequency domain segment of the set of multiple frequency domain segments. The operations of 1525 may be performed in accordance with examples as disclosed herein.

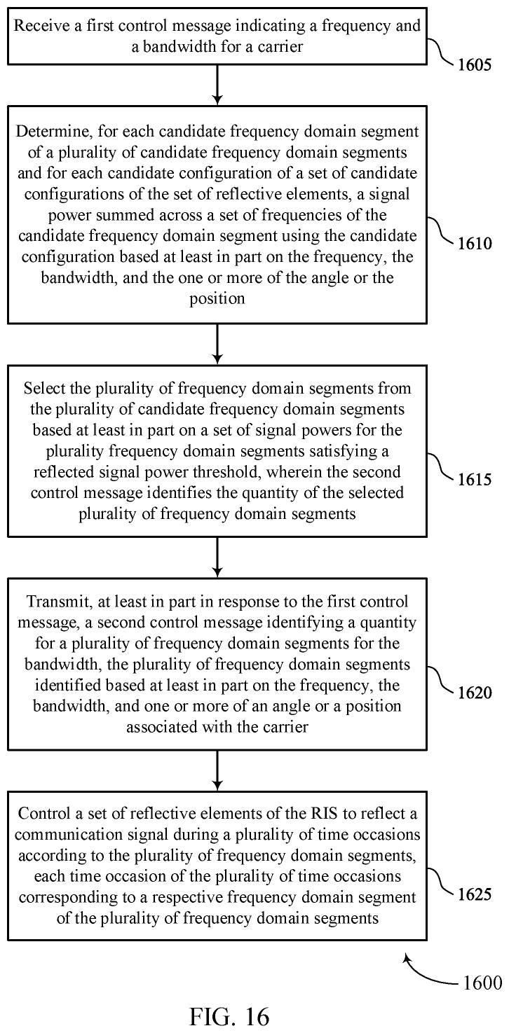

FIG. 16 shows a flowchart illustrating a method 1600 that supports large-bandwidth reconfigurable intelligent surface communication in accordance with one or more aspects of the present disclosure. The operations of the method 1600 may be implemented by a RIS or its components (e.g., a RIS CU or RIS, including reflective elements) as described herein. For example, the operations of the method 1600 may be performed by a RIS CU 315, RIS 305, or RIS 405. In some examples, the RIS CU 315 or RIS 405 may execute a set of instructions to control the functional elements of RIS 305 or RIS 405 to perform the described functions. Additionally, or alternatively, RIS CU 315 or RIS 405 may perform aspects of the described functions using special-purpose hardware, for example including a set of reflective elements.

At 1605, the method may include receiving a first control message indicating a frequency and a bandwidth for a carrier. The operations of 1605 may be performed in accordance with examples as disclosed herein.

At 1610, the method may include determining, for each candidate frequency domain segment of a set of multiple candidate frequency domain segments and for each candidate configuration of a set of candidate configurations of the set of reflective elements, a signal power summed across a set of frequencies of the candidate frequency domain segment using the candidate configuration based on the frequency, the bandwidth, and the one or more of the angle or the position. The operations of 1610 may be performed in accordance with examples as disclosed herein.

At 1615, the method may include selecting the set of multiple frequency domain segments from the set of multiple candidate frequency domain segments based on a set of signal powers for the plurality frequency domain segments satisfying a reflected signal power threshold, where the second control message identifies the quantity of the selected set of multiple frequency domain segments. The operations of 1615 may be performed in accordance with examples as disclosed herein.

At 1620, the method may include transmitting, at least in part in response to the first control message, a second control message identifying a quantity for a set of multiple frequency domain segments for the bandwidth, the set of multiple frequency domain segments identified based on the frequency, the bandwidth, and one or more of an angle or a position associated with the carrier. The operations of 1620 may be performed in accordance with examples as disclosed herein.

At 1625, the method may include controlling a set of reflective elements of the RIS to reflect a communication signal during a set of multiple time occasions according to the set of multiple frequency domain segments, each time occasion of the set of multiple time occasions corresponding to a respective frequency domain segment of the set of multiple frequency domain segments. The operations of 1625 may be performed in accordance with examples as disclosed herein.

The following provides an overview of aspects of the present disclosure:
Aspect 1: A method for wireless communication at a network entity, comprising: transmitting, to a RIS, a first control message indicating a frequency and a bandwidth for a carrier of a communication signal: receiving, from the RIS at least in part in response to the first control message, a second control message identifying a quantity for a plurality of frequency domain segments for the bandwidth of the communication signal; and communicating, via the RIS for each frequency domain segment of the plurality of frequency domain segments, the communication signal on the frequency domain segment during a time occasion of a plurality of time occasions, each time occasion of the plurality of time occasions corresponding to a respective frequency domain segment of the plurality of frequency domain segments.
Aspect 2: The method of aspect 1, wherein transmitting the first control message further comprises: transmitting, to the RIS, an indication of an incident angle of the communication signal at the RIS, an indication of a reflection angle for the communication signal at the RIS, or both.
Aspect 3: The method of any of aspects 1 through 2, wherein transmitting the first control message further comprises: transmitting, to the RIS, an indication of position information for the communication signal that is incident at the RIS, an indication of position information for the communication signal that is reflected from the RIS, or both.
Aspect 4: The method of any of aspects 1 through 3, wherein receiving the second control message comprises: receiving an indication of the quantity of the plurality of the frequency domain segments, wherein each of the plurality of frequency domain segments are evenly allocated in the bandwidth.
Aspect 5: The method of any of aspects 1 through 4, wherein receiving the second control message comprises: receiving an indication of the quantity of the plurality of the frequency domain segments and a respective bandwidth for each frequency domain segment of the frequency domain segments.
Aspect 6: The method of aspect 5, wherein at least one of the plurality of frequency domain segments are unevenly allocated in the bandwidth.
Aspect 7: The method of any of aspects 1 through 6, further comprising: transmitting, to the RIS for each time occasion of the plurality of time occasions, an indication of a frequency domain segment of the plurality of frequency domain segments to be used during the time occasion.
Aspect 8: The method of any of aspects 1 through 7, further comprising: transmitting, to the RIS, an indication of a correspondence between each time occasion of the plurality of time occasions and the respective frequency domain segment of the plurality of frequency domain segments.
Aspect 9: The method of any of aspects 1 through 8, wherein the second control message comprises a plurality of indicators corresponding to the plurality of frequency domain segments, the method further comprising: determining a correspondence between each time occasion of the plurality of time occasions and the respective frequency domain segment of the plurality of frequency domain segments based at least in part on an order of the plurality of indicators within the second control message.
Aspect 10: The method of any of aspects 1 through 9, further comprising: communicating, via the RIS, with a first UE during a first time occasion of the plurality of time occasions using a first frequency domain segment of the plurality of frequency domain segments; and communicating with a second UE during the first time occasion using a second frequency domain segment of the plurality of frequency domain segments at least in part in response to the first control message.
Aspect 11: A method for wireless communication at a RIS, comprising: receiving a first control message indicating a frequency and a bandwidth for a carrier; transmitting, at least in part in response to the first control message, a second control message identifying a quantity for a plurality of frequency domain segments for the bandwidth, the plurality of frequency domain segments identified based at least in part on the frequency, the bandwidth, and one or more of an angle or a position associated with the carrier; and controlling a set of reflective elements of the RIS to reflect a communication signal during a plurality of time occasions according to the plurality of frequency domain segments, each time occasion of the plurality of time occasions corresponding to a respective frequency domain segment of the plurality of frequency domain segments.
Aspect 12: The method of aspect 11, further comprising: determining, for each candidate frequency domain segment of a plurality of candidate frequency domain segments and for each candidate configuration of a set of candidate configurations of the set of reflective elements, a signal power at a center frequency of the candidate frequency domain segment using the candidate configuration based at least in part on the frequency, the bandwidth, and the one or more of the angle or the position; and selecting the plurality of frequency domain segments from the plurality of candidate frequency domain segments based at least in part on a set of signal powers for the plurality frequency domain segments satisfying a reflected signal power threshold, wherein the second control message identifies the quantity of the selected plurality of frequency domain segments.
Aspect 13: The method of any of aspects 11 through 12, further comprising: determining, for each candidate frequency domain segment of a plurality of candidate frequency domain segments and for each candidate configuration of a set of candidate configurations of the set of reflective elements, a signal power summed across a set of frequencies of the candidate frequency domain segment using the candidate configuration based at least in part on the frequency, the bandwidth, and the one or more of the angle or the position; and selecting the plurality of frequency domain segments from the plurality of candidate frequency domain segments based at least in part on a set of signal powers for the plurality frequency domain segments satisfying a reflected signal power threshold, wherein the second control message identifies the quantity of the selected plurality of frequency domain segments.
Aspect 14: The method of any of aspects 11 through 13, wherein receiving the first control message further comprises: receiving an indication of the one or more of the angle or the position, the one or more of the angle or the position comprising an indication of an incident angle of the communication signal at the RIS, an indication of a reflection angle for the communication signal at the RIS, or both.
Aspect 15: The method of any of aspects 11 through 14, wherein receiving the first control message further comprises: receiving an indication of the one or more of the angle or the position, the one or more of the angle or the position comprising an indication of position information for the communication signal that is incident at the RIS, an indication of position information for the communication signal that is reflected from the RIS, or both.
Aspect 16: The method of any of aspects 11 through 15, wherein transmitting the second control message comprises: transmitting an indication of the quantity of the plurality of the frequency domain segments, wherein each of the plurality of frequency domain segments are evenly allocated in the bandwidth.
Aspect 17: The method of any of aspects 11 through 16, wherein transmitting the second control message comprises: transmitting an indication of the quantity of the plurality of the frequency domain segments and a respective bandwidth for each frequency domain segment of the frequency domain segments.
Aspect 18: The method of aspect 17, wherein at least one of the plurality of frequency domain segments are unevenly allocated in the bandwidth.
Aspect 19: The method of any of aspects 11 through 18, further comprising: receiving, for each time occasion of the plurality of time occasions, an indication of a frequency domain segment of the plurality of frequency domain segments to be used during the time occasion.
Aspect 20: The method of any of aspects 11 through 19, further comprising: receiving an indication of a correspondence between each time occasion of the plurality of time occasions and the respective frequency domain segment of the plurality of frequency domain segments.
Aspect 21: The method of any of aspects 11 through 20, wherein the second control message comprises a plurality of indicators corresponding to the plurality of frequency domain segments, the method further comprising: ordering the plurality of indicators within the second control message in accordance with a correspondence between each time occasion of the plurality of time occasions and the respective frequency domain segment of the plurality of frequency domain segments.
Aspect 22: An apparatus for wireless communication at a network entity, comprising a processor: memory coupled with the processor; and instructions stored in the memory and executable by the processor to cause the apparatus to perform a method of any of aspects 1 through 10.
Aspect 23: An apparatus for wireless communication at a network entity, comprising at least one means for performing a method of any of aspects 1 through 10.
Aspect 24: A non-transitory computer-readable medium storing code for wireless communication at a network entity, the code comprising instructions executable by a processor to perform a method of any of aspects 1 through 10.
Aspect 25: An apparatus for wireless communication at a RIS, comprising a processor; memory coupled with the processor; and instructions stored in the memory and executable by the processor to cause the apparatus to perform a method of any of aspects 11 through 21.
Aspect 26: An apparatus for wireless communication at a RIS, comprising at least one means for performing a method of any of aspects 11 through 21.
Aspect 27: A non-transitory computer-readable medium storing code for wireless communication at a RIS, the code comprising instructions executable by a processor to perform a method of any of aspects 11 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a network entity, comprising:
a processor;
memory coupled with the processor; and
instructions stored in the memory and executable by the processor to cause the apparatus to:
transmit, to a reconfigurable intelligent surface (RIS), a first control message indicating a frequency and a bandwidth for a carrier of a communication signal;
receive, from the RIS at least in part in response to the first control message, a second control message identifying a quantity for a plurality of frequency domain segments for the bandwidth of the communication signal; and
communicate, via the RIS for each frequency domain segment of the plurality of frequency domain segments, the communication signal on the frequency domain segment during a time occasion of a plurality of time occasions, each time occasion of the plurality of time occasions corresponding to a respective frequency domain segment of the plurality of frequency domain segments.

2. The apparatus of claim 1, wherein the instructions to transmit the first control message are further executable by the processor to cause the apparatus to:
transmit, to the RIS, an indication of an incident angle of the communication signal at the RIS, an indication of a reflection angle for the communication signal at the RIS, or both.

3. The apparatus of claim 1, wherein the instructions to transmit the first control message are further executable by the processor to cause the apparatus to:
transmit, to the RIS, an indication of position information for the communication signal that is incident at the RIS, an indication of position information for the communication signal that is reflected from the RIS, or both.

4. (canceled)

5. The apparatus of claim 1, wherein the instructions to receive the second control message are executable by the processor to cause the apparatus to:
receive an indication of the quantity of the plurality of the frequency domain segments and a respective bandwidth for each frequency domain segment of the frequency domain segments.

6. The apparatus of claim 5, wherein at least one of the plurality of frequency domain segments are unevenly allocated in the bandwidth.

7. The apparatus of claim 1, wherein the instructions are further executable by the processor to cause the apparatus to:
transmit, to the RIS for each time occasion of the plurality of time occasions, an indication of a frequency domain segment of the plurality of frequency domain segments to be used during the time occasion.

8. The apparatus of claim 1, wherein the instructions are further executable by the processor to cause the apparatus to:
transmit, to the RIS, an indication of a correspondence between each time occasion of the plurality of time occasions and the respective frequency domain segment of the plurality of frequency domain segments.

9. (canceled)

10. The apparatus of claim 1, wherein the instructions are further executable by the processor to cause the apparatus to:
communicate, via the RIS, with a first user equipment (UE) during a first time occasion of the plurality of time occasions using a first frequency domain segment of the plurality of frequency domain segments; and
communicate with a second UE during the first time occasion using a second frequency domain segment of the plurality of frequency domain segments at least in part in response to the first control message.

11. An apparatus for wireless communication at a reconfigurable intelligent surface (RIS), comprising:
a processor;
memory coupled with the processor; and
instructions stored in the memory and executable by the processor to cause the apparatus to:
receive a first control message indicating a frequency and a bandwidth for a carrier;
transmit, at least in part in response to the first control message, a second control message identifying a quantity for a plurality of frequency domain segments for the bandwidth, the plurality of frequency domain segments identified based at least in part on the frequency, the bandwidth, and one or more of an angle or a position associated with the carrier; and
control a set of reflective elements of the RIS to reflect a communication signal during a plurality of time occasions according to the plurality of frequency domain segments, each time occasion of the plurality of time occasions corresponding to a respective frequency domain segment of the plurality of frequency domain segments.

12. The apparatus of claim 11, wherein the instructions are further executable by the processor to cause the apparatus to:
determine, for each candidate frequency domain segment of a plurality of candidate frequency domain segments and for each candidate configuration of a set of candidate configurations of the set of reflective elements, a signal power at a center frequency of the candidate frequency domain segment using the candidate configuration based at least in part on the frequency, the bandwidth, and the one or more of the angle or the position; and
select the plurality of frequency domain segments from the plurality of candidate frequency domain segments based at least in part on a set of signal powers for the plurality frequency domain segments satisfying a reflected signal power threshold, wherein the second control message identifies the quantity of the selected plurality of frequency domain segments.

13. The apparatus of claim 11, wherein the instructions are further executable by the processor to cause the apparatus to:
determine, for each candidate frequency domain segment of a plurality of candidate frequency domain segments and for each candidate configuration of a set of candidate configurations of the set of reflective elements, a signal power summed across a set of frequencies of the candidate frequency domain segment using the candidate configuration based at least in part on the frequency, the bandwidth, and the one or more of the angle or the position; and
select the plurality of frequency domain segments from the plurality of candidate frequency domain segments based at least in part on a set of signal powers for the plurality frequency domain segments satisfying a reflected signal power threshold, wherein the second control message identifies the quantity of the selected plurality of frequency domain segments.

14. The apparatus of claim 11, wherein the instructions to receive the first control message are further executable by the processor to cause the apparatus to:
receive an indication of the one or more of the angle or the position, the one or more of the angle or the position comprising an indication of an incident angle of the communication signal at the RIS, an indication of a reflection angle for the communication signal at the RIS, or both.

15. The apparatus of claim 11, wherein the instructions to receive the first control message are further executable by the processor to cause the apparatus to:
receive an indication of the one or more of the angle or the position, the one or more of the angle or the position comprising an indication of position information for the communication signal that is incident at the RIS, an indication of position information for the communication signal that is reflected from the RIS, or both.

16. The apparatus of claim 11, wherein the instructions to transmit the second control message are executable by the processor to cause the apparatus to:
transmit an indication of the quantity of the plurality of the frequency domain segments, wherein each of the plurality of frequency domain segments are evenly allocated in the bandwidth.

17. The apparatus of claim 11, wherein the instructions to transmit the second control message are executable by the processor to cause the apparatus to:
transmit an indication of the quantity of the plurality of the frequency domain segments and a respective bandwidth for each frequency domain segment of the frequency domain segments.

18. The apparatus of claim 17, wherein at least one of the plurality of frequency domain segments are unevenly allocated in the bandwidth.

19. The apparatus of claim 11, wherein the instructions are further executable by the processor to cause the apparatus to:
receive, for each time occasion of the plurality of time occasions, an indication of a frequency domain segment of the plurality of frequency domain segments to be used during the time occasion.

20. The apparatus of claim 11, wherein the instructions are further executable by the processor to cause the apparatus to:
receive an indication of a correspondence between each time occasion of the plurality of time occasions and the respective frequency domain segment of the plurality of frequency domain segments.

21. The apparatus of claim 11, wherein the second control message comprises a plurality of indicators corresponding to the plurality of frequency domain segments, and the instructions are further executable by the processor to cause the apparatus to:
order the plurality of indicators within the second control message in accordance with a correspondence between each time occasion of the plurality of time occasions and the respective frequency domain segment of the plurality of frequency domain segments.

22. A method for wireless communication at a network entity, comprising:
transmitting, to a reconfigurable intelligent surface (RIS), a first control message indicating a frequency and a bandwidth for a carrier of a communication signal;
receiving, from the RIS at least in part in response to the first control message, a second control message identifying a quantity for a plurality of frequency domain segments for the bandwidth of the communication signal; and
communicating, via the RIS for each frequency domain segment of the plurality of frequency domain segments, the communication signal on the frequency domain segment during a time occasion of a plurality of time occasions, each time occasion of the plurality of time occasions corresponding to a respective frequency domain segment of the plurality of frequency domain segments.

23-30. (canceled)
